(19) United States
(12) Patent Application Publication
(10) Pub. No.: US 2011/0071862 A1
(43) Pub. Date: Mar. 24, 2011

(54) COLLABORATION AND TRAVEL ECOSYSTEM

(75) Inventors: Anita Cator, Keller, TX (US); Srinivas Chintha, Bangalore (IN); James French, Southlake, TX (US); Ryan Merritt, Keller, TX (US); Suzanne Neufang, Southlake, TX (US); Trey Pace, Richardson, TX (US); Cassandra Rollins, Sacramento, CA (US); Jeremy Stubbs, Keller, TX (US); Shelly Terry, North Richland Hills, TX (US); Ben Vinod, Grapevine, TX (US); Paul Wiley, Colleyville, TX (US)

(73) Assignee: GetThere, L.P., Southlake, TX (US)

(21) Appl. No.: 12/890,483

(22) Filed: Sep. 24, 2010

Related U.S. Application Data
(60) Provisional application No. 61/245,591, filed on Sep. 24, 2009.

(51) Int. Cl. G06Q 10/00

(52) U.S. Cl. 705/5; 705/7

(57) ABSTRACT

Methods, systems and apparatuses related to providing, among other things, a collaboration and travel ecosystem are discussed herein. For example, various tools and functionality may be provided that assist a client in determining the availability of telepresence equipment, the cost to use the telepresence equipment, the potential return on investment for money spent traveling as compared to conducting a telepresence event, among other things. In some embodiments, a user interface may be presented to a client that presents various information associated with, e.g., the telepresence equipment and/or facilitates the booking of the telepresence equipment. One or more backend systems may be used to, for example, coordinate the booking of a telepresence event and/or the booking of traditional travel events. In some embodiments, business rules and/or other types of data may be generated, received, maintained and/or received by the backend system(s).

### CROSS-REFERENCE TO RELATED APPLICATION

This patent application claims priority to U.S. Provisional Patent Application No. 61/245,591, filed Sep. 24, 2009, titled “COLLABORATION AND TRAVEL ECOSYSTEM,” which is hereby incorporated by reference in its entirety.

### FIELD

Some embodiments of this disclosure relate to systems, methods, computer readable media and other means for arranging and coordinating multilateral distance conferencing.

### BACKGROUND

Corporate travel can be broadly divided into several categories, including internal meetings, conferences, training sessions, sales meetings, and client meetings. In some instances, instead of using travel budgets to pay for travel-related expenses, some businesses have elected to use travel budgets to purchase video conferencing tools offered by companies like Cisco Systems and Hewlett-Packard. These companies and others have been promoting state-of-the-art video conferencing systems, sometimes referred to as telepresence systems. The Cisco Systems' TelePresence® and Hewlett-Packard's Halo® telepresence and video conferencing solutions are not, however, (currently) inter-operable. Nevertheless, corporations and other businesses have been investing in these video conferencing systems in an effort to curtail future travel expenses for various types of meetings.

Seeing this emerging trend, some hotel companies are also investing in video conferencing and/or telepresence equipment. The equipment is installed in hotel conference rooms, which can then be rented by the hour and include the use of the conferencing equipment. Hotels view this capability to rent video conferencing as a potentially significant source of revenue that will hopefully offset lower room occupancy caused by the installation of telepresence and video conferencing systems at businesses.

### BRIEF SUMMARY

Embodiments discussed herein include systems, methods, computer readable media and other means for providing integration of collaboration alternatives into travel work flow and decision processes. These may include travel workflow executed by online tools (such as an online business travel booking tool like GetThere® tools) as well as travel workflow done through offline, telephonic channels using a global distribution system (including, e.g., travel agents). Users of either (online and offline) travel workflow process are provided the tools included in some embodiments of the present invention to shop and/or book travel, telepresence meeting equipment, and/or other collaboration services through one or more a centralized systems.

When a user of an online travel workflow tool is trying to shop or book services, some embodiments may provide the user travel options as well as travel alternatives (including other forms of meetings, such as telepresence meetings). Each of these options may be generated by one or more remote systems and be presented to the user at the user's machine. For example, the user may be presented the option to reserve a hotel or other type of conference room to conduct a telepresence meeting.

In providing these features, some embodiments of the present invention include a collaboration and travel ecosystem comprising a series of features, some examples of which are described herein. Some embodiments can integrate various types of collaboration alternatives into a single travel workflow and/or decision processes in both online and offline environments. Infusing these alternatives into the travel workflow and/or decision process may include enhanced features relating to searching, pricing, shopping, booking and fulfilling requests in a collaborative environment.

As another example, a return on investment calculator for collaboration services can be used to determine whether an estimated cost for physical travel in combination with various intangible benefits that may be realized with an in-person meeting out weighs the expected cost savings of using virtual collaboration technology. In some embodiments, for example, a return on investment calculator may be configured to determine the return on the money spent physically traveling to a distant location on business. These estimates can be used to determine whether the travel is likely to be justified in light of the expenses required to physically travel. The return on investment calculator can also be integrated into business travel workflow and/or decision processes in both online and offline environments.

Embodiments of the invention can also utilize a telepresence host system that may facilitate the implementation of various associated processes used to fulfill a client's remote collaboration needs. By virtue of using at least one centralized system to reserve both telepresence equipment as well as physical travel itineraries, the system can be configured to have access to the availability status and serve as the system of record for all types of inventory availability.

The telepresence host system can enable virtual collaboration by, for example, being configured to aggregate available inventory, pricing and booking across multiple travel and collaboration host systems, sometimes referred to herein as telepresence providers. The information collected about various telepresence providers can allow telepresence host system to provide end-user tools, such as an online travel workflow tool and an offline travel workflow tool. The telepresence host system can be collaboration and distribution and/or computer reservation system agnostic, and serve as the system of record for all video conference suppliers that distribute through the central system. In doing so, the telepresence global distribution system can act as a telepresence/virtual meeting aggregator and distribution solution (integrated into online/offline travel booking environments). This includes the concept of “meet-me-in-the-middle” capability to optimize the itineraries of all employee-participants. The default logic for determining the “middle” city where to meet can be based on, among other things, collaboration requirements and cost. The default logic can also be geographically independent or geographically dependent (e.g., dependent on whether the bookings are scheduled for the U.S., Europe, or globally). In addition, estimated seat values, which can be stored in a pre-computed estimated seat values cache for subsequent itinerary planning, can be used to generate an estimated cost and determine the best (e.g., least expensive) location to use as a node for establishing a telepresence conferencing bridge to anywhere in the world.

Embodiments of the present invention can also be integrated into corporate booking engines and, more broadly, the corporate community, as well as be used to provide a competitive pricing capability and to establish prices by time slot for, e.g., video conference suppliers, telepresence suppliers, and/or purveyors of other equipment that can be distributed through the central system.

### SUMMARY OF THE DRAWINGS

Having thus described the invention in general terms, reference will now be made to the accompanying drawings, which are not necessarily drawn to scale, and wherein:

FIGS. 1A and 1B show a collaboration management system that is in accordance with some embodiments discussed herein;

FIG. 2 shows a block diagram of components that may be included in an example distribution system in accordance with some example embodiments discussed herein;

FIG. 3 shows a block diagram of components that may be included in an example telepresence host system in accordance with some example embodiments discussed herein;

FIGS. 4-6 show exemplary displays that may be generated and presented by systems in accordance with some embodiments discussed herein;

FIG. 7 shows a flow diagram in accordance with some example embodiments discussed herein;

FIG. 8 shows a type of collaboration event that may be realized using some embodiments discussed herein;

FIG. 9 shows a block diagram of components and variables that may be used by some embodiments discussed herein;

FIGS. 10A and 10B show exemplary displays that may be generated and presented by systems in accordance with some embodiments discussed herein;

FIG. 11 shows a block diagram of the budgets of an organizational structure that may be utilized by some embodiments discussed herein;

FIG. 12 shows a flow diagram in accordance with some example embodiments discussed herein; and

FIG. 13 shows exemplary displays that may be generated and presented by systems in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments include systems, methods, computer readable media and other means for arranging, coordinating and servicing the conducting of multilateral distance conferencing. While distance conferencing can be arranged absent physical travel arrangements (such as those for a hotel, airfare, and a rental car), embodiments of the invention also include integrating physical travel arrangements with the distance conferencing arrangements.

Additionally, some embodiments may provide tools and/or other types of functionality for a fee (e.g., subscription fee, flat fee, and/or based on any other type of fee arrangement) or free of fee as a courtesy to one or more users, which are sometimes referred to herein as “clients.”

### System Infrastructure

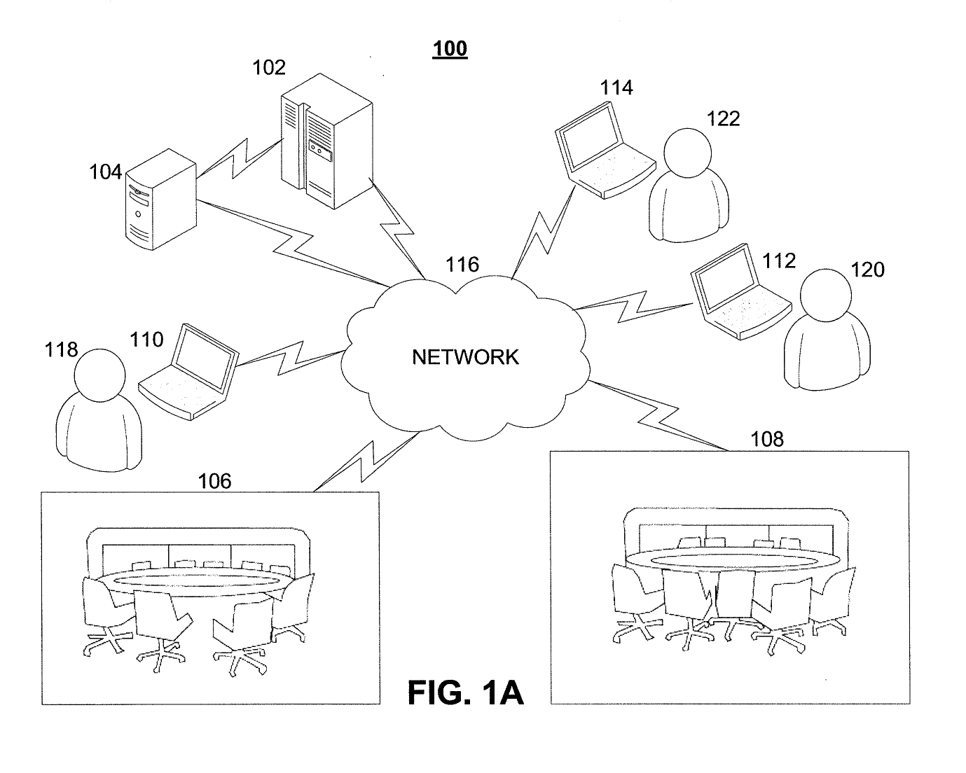

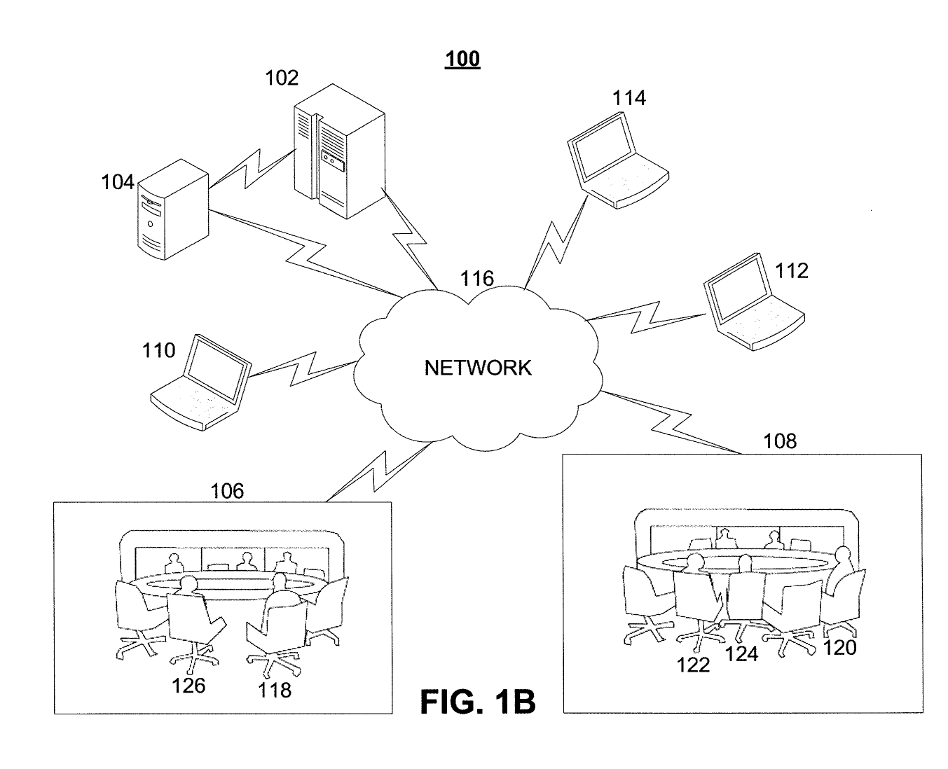

FIG. 1 shows a block diagram of exemplary collaboration management system 100 in which embodiments of the present invention can be implemented. Collaboration management system 100 includes distribution system 102, telepresence host system 104, telepresence providers 106 and 108, and telepresence requestors 110, 112 and 114, which may be used by, e.g., clients 118, 120 and 122. Each machine can communicate with other machines using network 116, which may include, among other things, the public Internet, intranets, other network(s), and/or one or more direct connections between two or more of the machines. Additional examples related to network 116 are discussed below.

Distribution system 102 can include or otherwise access one or more computer reservation systems, global distribution systems, and/or any other type of system that can be configured to, among other things, retrieve, receive, and/or store information related to organizing meetings, travel arrangements and/or other types of collaboration services. As referred to herein, “collaboration services” and “collaboration events” include, for example, physical travel accommodations (e.g., airline, hotel, rental car, etc.), telepresence meeting accommodations (e.g., use of telepresence and/or other types of moving image conferencing equipment) as well as any other type of event that enables people to collaborate.

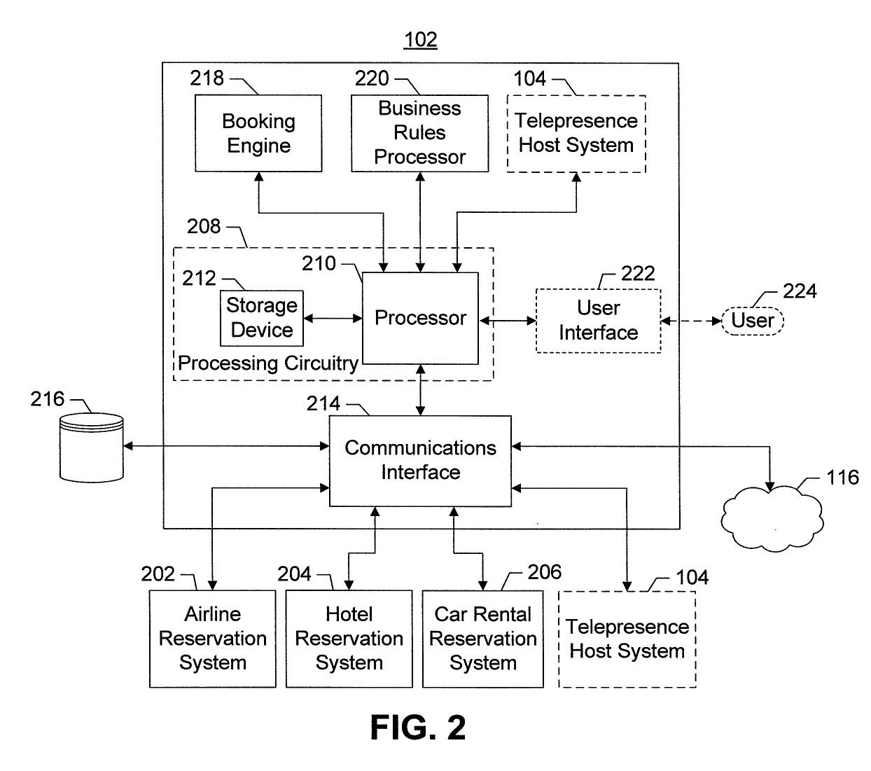

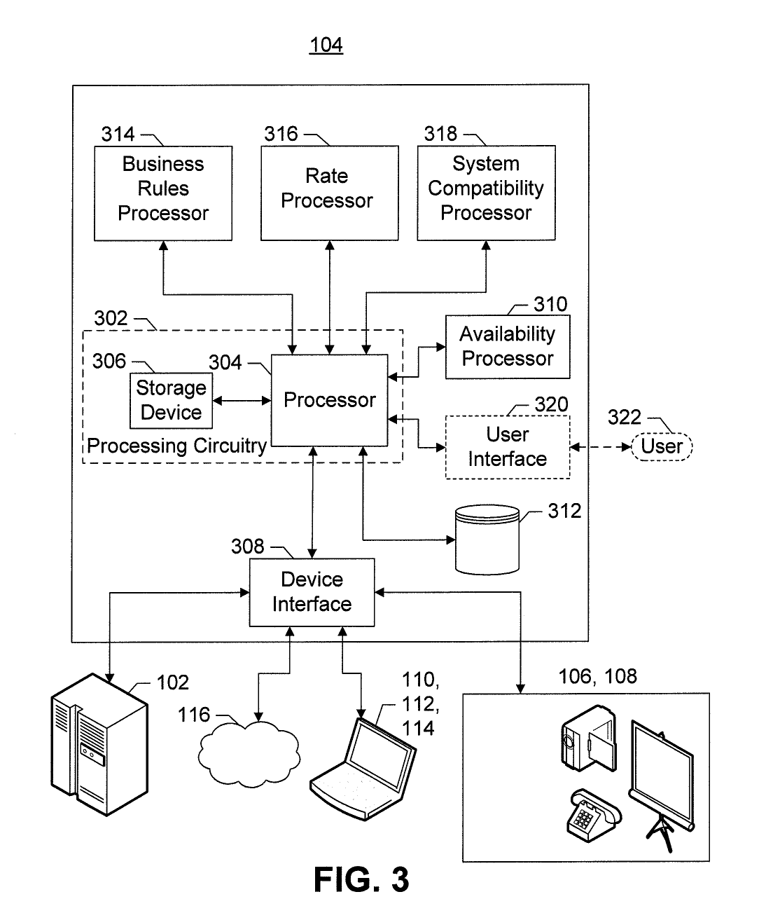

For example, as shown in FIG. 2, distribution system 102 may request, receive and/or otherwise access information from one or more computerized airline reservation systems 202, hotel reservation systems 204, car rental reservation systems 206, and/or telepresence host systems 104. Exemplary components of telepresence host system 104 are shown and discussed in reference to FIG. 3. Airline reservation systems 202, hotel reservation systems 204, car rental reservation systems 206 and/or telepresence host system 104 may be any type of system(s) that may enable one or more telepresence requestors 110, 112, 114, travel agent(s) (not shown), and/or any other type of machine being used by a client to schedule, pay for, and/or otherwise reserve collaboration services.

In some embodiments, telepresence host system 104 may be directly connected to distribution system 102 (as shown in FIGS. 1-3), may be incorporated into distribution system 102 (as shown in FIG. 2), and/or be otherwise connected to distribution system 102 (e.g., through a public network, such as network 116). For example, a telepresence host system dedicated specifically to distribution system 102 may be incorporated into distribution system 102 and connected directly to processing circuitry 208 of the distribution system 102, enabling distribution system 102 to be configured to coordinate telepresence events. Processing circuitry 208 of distribution system 102 can also be configured to perform data processing for telepresence providers 106 and 108 and/or telepresence requestors 110, 112 and 114 based on requests received via network 116. For example, processing circuitry 208 may be configured to extract data from a request, which may have been generated by telepresence requestor 110, to schedule a collaboration event. The extracted data may, for example, identify a date and a location associated with a desired collaboration event.

Processing circuitry 208 may include various means for implementing various functionality, including circuitry comprising microprocessors, coprocessors, controllers, special-purpose integrated circuits such as, for example, ASICs (application specific integrated circuits), FPGAs (field programmable gate arrays), hardware accelerators, and/or any other type of hardware. According to some example embodiments, processing circuitry 208 may include processor 210, which may be representative of a plurality of processors operating in concert. Processor 210 may, but need not, include one or more accompanying digital signal processors. In some example embodiments, processor 210 is configured to execute instructions stored in storage device 212 or instructions otherwise accessible to the processor 210. Whether configured as hardware or via instructions stored on a computer-readable storage medium (such as storage device 212), or by a combination thereof, processor 210 may be an entity capable of performing actions according to embodiments of the present invention while configured accordingly. Thus, in example embodiments where processor 210 is embodied as an ASIC, FPGA, or the like, processor 210 is specifically configured hardware for conducting the actions, some examples of which are described herein. Alternatively or additionally, in example embodiments where processor 210 is embodied as an executor of instructions stored on a computer-readable storage medium, the instructions specifically configure processor 210 to perform the algorithms and actions, some examples of which are described herein. In some example embodiments, processor 210 is a processor of a specific device (e.g., distribution system 102) configured for employing example embodiments of the present invention by further configuration of processor 210 via executed instructions for performing the algorithms and actions described herein.

Storage device 212 may comprise one or more computer-readable storage media, such as volatile and/or non-volatile memory. Storage device 212 may be contrasted with a computer-readable transmission medium, such as a propagating signal. In some example embodiments, storage device 212 comprises random access memory (“RAM”) including dynamic and/or static RAM, on-chip or off-chip cache memory, and/or the like. Further, storage device 212 may comprise non-volatile memory, which may be embedded and/or removable, and may comprise, for example, read-only memory, flash memory, one or more magnetic storage devices (e.g., hard disks, floppy disk drives, magnetic tape, etc.), optical disc drives and/or media, non-volatile random access memory (NVRAM), and/or the like. Storage device 212 may comprise a cache area for temporary storage of data. In this regard, some or all of storage device 212 may be included within processing circuitry 208.

Further, storage device 212 may be configured to store information, data, applications, computer-readable program code instructions, or the like for enabling processor 210 to carry out various functions in accordance with example embodiments of the present invention described herein. For example, storage device 212 could be configured to buffer input data for processing by processor 210. Additionally, or alternatively, storage device 212 may be configured to store instructions for execution by processor 210.

When telepresence host system 104 is located external to or otherwise not connected directly to processing circuitry 208, communications interface 214 may be configured to facilitate communications between processing circuitry 208 and telepresence host system 104 as well as any other type of external device, such as airline reservation system 202, hotel reservation 204, car rental reservation system 206, and/or any device connected to network 116. Like other components discussed herein, communications interface 214 may include any component, device and/or other means embodied in hardware, a computer program product, or a combination of hardware and a computer program product that is configured to receive and/or transmit data from/to a network and/or any other device and/or module in communication with distribution system 102. Processor 210 may also be configured to facilitate communications via communication interface 214 by, for example, controlling hardware included within the respective components. In this regard, communication interface 214 may comprise, for example, one or more antennas, a transmitter, a receiver, a transceiver and/or supporting hardware, comprising a processor for enabling communications with network 116, computer reservation systems, telepresence host systems, and/or any other apparatus and/or system. Via communication interface 214 and network 116, distribution system 102 may communicate with various other network entities, including telepresence requestors 110, 112 and 114, and/or receive various inputs in a device-to-device fashion and/or via indirect communications via a base station, access point, server, gateway, router, or the like.

Communications interface 214 may be configured to provide communications in accordance with any wired or wireless communication standard and/or communications technique. For example, communications interface 214 may be configured to communicate using techniques involving radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15 (BlueTooth®), and/or the like.

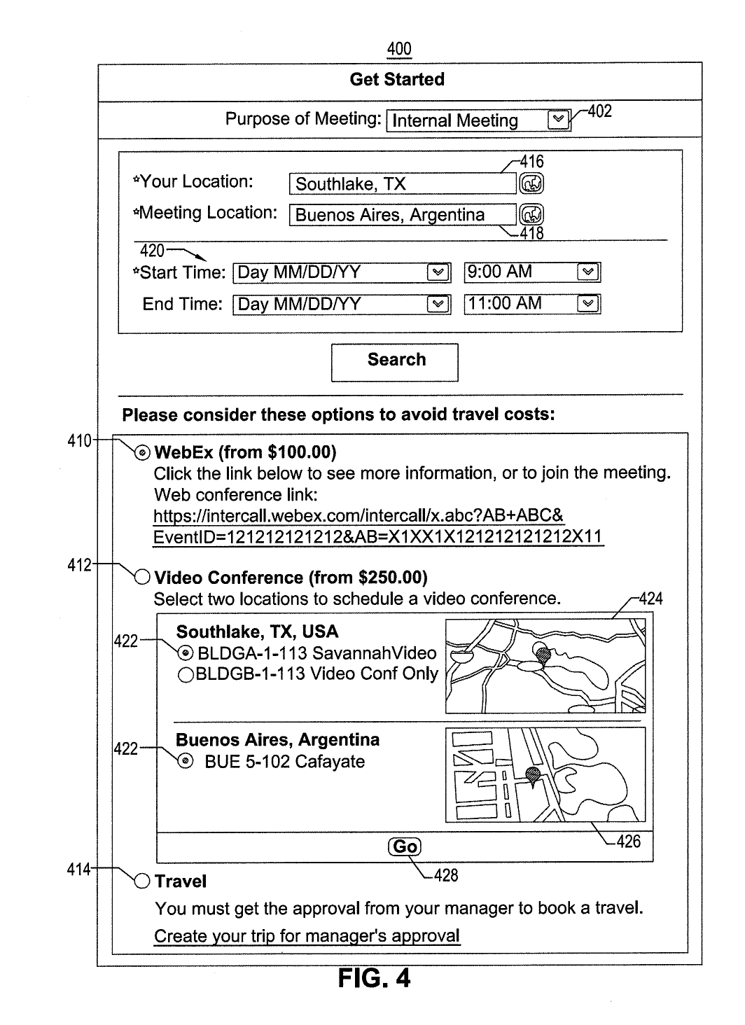

For example, distribution system 102 can use communications interface 214 to transmit data associated with the availability of resources configured to provide collaboration services at various telepresence providers, such as telepresence providers 106 and 108 (shown in FIGS. 1A and 1B). The data generated by distribution system 102, telepresence host system 104, and/or other apparatuses of collaboration management system 100 (including other types of computer reservation systems) may be presented to a user as a webpage, such as those discussed in connection with FIGS. 4-6, 10A, 10B and 13.

For example, distribution system 102 may serve as a reservation system that calculates and reserves travel plans as well as multi-media distant telepresence equipment and space (such as that associated with, e.g., telepresence providers 106 and 108). In doing so and as noted above, distribution system 102 may communicate with (directly or indirectly) telepresence host system 104 and/or a plurality of computer reservation systems associated with airlines, hotels, car rentals, and/or other forms of physical travel-related services. Accordingly, distribution system 102 can assist a client in booking one or more collaboration services, including one or more travel item segments from any one of the accessible computer reservation systems. As referred to herein, “travel item segment” can be an air segment, a car segment, a hotel segment, a train segment or other types of useful segments related to travel.

Computer reservation systems for particular travel item segments can be predefined for one or more clients, such as for some corporate clients. For example, a storage device, such as storage device 212 and/or database 216, can be configured to store information associated with the predefined travel item segments along with other client-specific information, including particular conditions and/or other types of business rules that should be satisfied when scheduling collaboration services (e.g., preferred airlines, preferred hotels, types of compatible telepresence equipment, etc.).

To provide client-specific and/or other types of reservation services, distribution system 102 may include booking engine 218 and/or business rules processor 220. Business rules processor 220 can be used to manage business rules that define, for example, selections of one or more computer reservation systems (e.g., global distribution system and/or direct connect computer reservation systems) to be accessed during the travel booking request of a client. For example, prior to requesting a travel booking from a computer reservation system and/or telepresence host system, distribution system 102 may be configured to utilize business rules processor 220 to determine which computer reservation systems and/or telepresence host systems to utilize for one or more specific clients. When a client first decides to, for example, use distribution system 102 for travel item bookings, the client may first define which computer reservation system(s) to use for particular travel items and/or segments as well as under what conditions. For example, Company A may only want distribution system 102 to schedule airline reservations based on the following business rule: UNITED for airline reservations (e.g., via the APOLLO global distribution system) but if that is unavailable check SOUTHWEST (e.g., via the SABRE global distribution system). Alternatively, Company B may have a business rule that causes distribution system 102 to check both UNITED (e.g., via the APOLLO global distribution system) and SOUTHWEST (e.g., via the SABRE global distribution system) for the lowest cost airline reservations, to check HERTZ for car rentals (e.g., via the SABRE global distribution system) but if that is unavailable check AVIS (e.g., via the APOLLO global distribution system), and to use RAMADA only for hotel reservations (e.g., via Direct Connect computer reservation system to RAMADA).

To enable the functionality of business rules processor 220, distribution system 102′s site implementation consultant, other user and/or other component of system 100 may program one or more predefined computer reservation systems and/or conditions into distribution system 102 for the particular client. The predefined computer reservation systems and/or conditions for the client can be stored in a database accessible by distribution system 102, such as database 216, storage device 212, and/or an internal database (not shown). When the client logs on to distribution system 102, the predefined computer reservation systems and/or conditions can be made available to the booking engine included in of distribution system 102. The booking engine reads the database to determine and set the predefined computer reservation systems and/or conditions for the client and accesses the predefined computer reservation systems and/or conditions from the network to check the availability of travel items for the client.

Booking engine 218 can be configured to receive data from an internal storage device, such as storage device 212, and/or an external storage device, such as database 216, and/or any other storage device (remote or local to distribution system 102) to determine whether the predefined computer reservation systems have any availability in response to receiving a client request. In some embodiments, booking engine 218 may also be configured to determine whether one or more telepresence providers have any availability. In some embodiments, booking engine 218 may be configured to poll one or more telepresence host systems to determine availability of one or more telepresence providers. Telepresence host systems, such as telepresence host system 104 may obtain (e.g., pull and/or have pushed thereto) schedule information from one or more telepresence providers, such as telepresence providers 106 and 108. Additional examples of how telepresence host system 104 may receive schedule information from telepresence providers 106 and 108 are discussed below.

The available travel items may be displayed via a client interface of one or more of the telepresence requestors 110, 112 and 114 for booking. When the client selects a travel item segment for booking, the booking engine books the travel item with the respective computer reservation systems, and the booked travel item segment is stored in a super passenger name record in distribution system 102′s database, such as database 216. The booking records can be retrieved as well as predefined computer reservation systems (e.g., client profiles or configurations), etc. In some embodiments, the computer reservation system's designation (e.g., the name of the computer reservation system and/or the computer reservation system locator) is associated with each travel item segment. The booking record can then be accessed by the telepresence requestors 110, 112 and/or 114 for modification. Also, in some embodiments, telepresence requestors 110, 112 and 114 can be operated by or coupled to, for example, travel agencies and/or corporate clients that fulfill tickets booked through distribution system 102.

User interface 222 may be in communication with processing circuitry 208 to receive user input(s) from, for example, a system administrator. For example, user interface 222 may include hardware, software and/or firmware for a keyboard, mouse, track pad, multi-touch screen, microphone, camera, and/or any other input component with which user 224 may interact. User interface 222 may also be configured to present output to user 224. For example, user interface 222 may include hardware, software and/or firmware for a display (e.g., a touch screen display), a speaker, and/or any other type of audible, visual, mechanical (including tactile) that can provide output indications to user 224.

Referring back to FIG. 1A, telepresence providers 106 and 108 may include multi-media equipment that enables video conferencing to occur. For example, telepresence providers 106 and 108 can include one or more video cameras, microphones, speakers, display screens, keyboard, remote control(s), touch interface, other input devices (e.g., computer mouse), processing units (such as, e.g., a personal computer), network connection devices, any necessary software, any other device, and/or any combination thereof. Cisco Systems' TelePresence® and Hewlett-Packard's Halo® are exemplary telepresence conferencing solutions (albeit they are not (currently) operable with each other). Telepresence providers 106 and 108 can each be physically located in a corporation's conference room, hotel conference center, interne café, personal home, and/or any other physical location that can house multimedia and other teleconferencing equipment, such as those operated by Tata Communications.

The telepresence requestors 110, 112 and 114 booking and modification functionality can include utilizing a web browser. For example, the web browser can present a client interface, for example, via HTML-specific Java Server Pages (JSP), using the Hypertext Transfer Protocol (HTTP) and Hypertext Markup Language (HTML) or Extensible Markup Language (XML) code. Telepresence requestors 110, 112 and 114 that utilize this functionality permit the client to first select whether or not they would like to make travel bookings using, for example, reservation systems 202, 204 and 206 for different travel item segments (e.g. air, hotel and car), such that the client can choose and book the best travel item segment to suit their needs from any one of the accessible computer reservation systems. Also, the client interface of telepresence requestors 110, 112 and 114 can display the booking record associated with, e.g., a super passenger name record (representing the client's booked itinerary) and allow the client to create, change, or cancel booked travel item segments, even though each segment may have been made through a different computer reservation system, but via the same telepresence requestor 110, 112 or 114. Thus, in accordance with some embodiments, a client 118, 120 or 122 of collaboration management system 100 can transparently make travel bookings using distribution system 102 to choose the best travel item. This sort of booking, even though it may use multiple computer reservation systems, can seem indistinguishable from a regular booking using a standard global distribution system from a client's perspective.

The systems and methods for travel management for making travel related bookings according to embodiments of the present invention can be implemented as one or more instructions (e.g., code segments) to perform the desired functions of allowing a client to make travel bookings from the plurality of computer reservation systems for different travel item segments (e.g., air, car, and hotel) such that the client can choose and book the best travel item segment from any one of the accessible computer reservation systems, modify a super passenger name record booking record representing the client's booked itinerary, as well as the many other functions (as will be discussed in greater detail later). The instructions which when read and executed by a processor, cause the processor to perform the operations necessary to implement and/or use embodiments of the invention. Generally, the instructions are tangibly embodied in and/or readable from a machine-readable medium, device, or carrier, such as memory, data storage devices, and/or a remote device contained within or coupled to the super passenger name record collaboration management system 100. The instructions may be loaded from memory, data storage devices, and/or remote devices into the memory of the distribution system 102 for use during operations.

A global distribution system, such as distribution system 102, can also be configured to connect a set of internally and/or externally networked databases, and employ the business logic that ties them together. Global distribution systems can be used to manage the sale of airline, car rental, and hotel inventories provided by individual computer reservation systems. For example, the global distribution system can also be connected to one or more independent computer reservation systems with which the global distribution system has a business relationship. In some embodiments, computer reservation systems can now be connected to directly or otherwise to one another, allowing the end user, such as client 118, 120 or 122 to make bookings without going through a global distribution system, which are sometimes referred to herein as “direct connect computer reservation systems.”

Similarly, telepresence host system 104 may be included in distribution system 102 or may be implemented independently from any type of computer reservation or global distribution system. Telepresence host systems, such as telepresence host system 104, can be used to manage the scheduling and usage of telepresence equipment provided by individual telepresence providers, such as telepresence providers 106 and/or 108. For example, telepresence host system 104 may receive requests from telepresence requestors 110, 112 and 114, which may be used by clients 118, 120 and 122. Telepresence requestors 110, 112 and 114 may contact telepresence host system 104 to reserve telepresence providers 106 and 108, view the availability of telepresence providers 106 and 108, make travel reservations, and/or cancel previously scheduled reservations. Accordingly, as discussed further below, distant conferencing can be scheduled using collaboration management system 100 similar to and in conjunction with the booking of travel itineraries.

Telepresence host system 104 can also be directly connected to one or more independent computer reservation systems (such as, e.g., distribution system 102, airline reservation system 202, hotel reservation system 204 and/or car rental reservation system 206). Telepresence host system 104 may be configured to give preference to one or more preferred computer reservation systems with which, for example, telepresence host system 104 may have a business relationship. Additional examples are provided below (such as in reference to the discussion of FIG. 3) as to how telepresence host system 104 may access and/or update the availability of equipment associated with one or more telepresence providers 106 and 108.

In some embodiments, the end user, such as clients 118, 120 or 122, may book the equipment made available by telepresence providers 106 and/or 108 without going through a global distribution system and/or other type of computer reservation system. For example, telepresence requestors 110, 112 and 114 may connect directly to a stand alone telepresence host system 104 through network 116. As noted herein, network 116 may be any type or types of network, including a corporate intranet and/or public network. Telepresence host system 104 may be configured to connect a set of internally and/or externally networked databases and employ the business logic that ties them together.

After clients 118, 120 and 122 have booked (e.g., reserved and/or paid for) telepresence equipment provided by telepresence providers 106 and 108, the clients may assemble at telepresence providers 106 and 108 to collaborate as shown in FIG. 1B. Additional clients, such as clients 124 and 126, may join in the collaboration. In some embodiments, one or more of clients 118, 120, 122, 124 and 126 may have to physically travel to one of telepresence providers 106 and 108. Collaboration management system 100 and/or any other system may be used to book the physical travel arrangements as well. One or more of clients 118, 120, 122, 124 and 126 may be able to collaborate without making physical travel arrangements. For example, telepresence provider 106 and/or telepresence provider 108 may be located within (or near) at least one of the client's place of business, such as in a conference room. In this manner, telepresence host system 104 may be configured to function as an internal reservation system for privately available equipment in addition to or instead of being configured to function as a public reservation system for publicly available equipment.

Telepresence requestors 110, 112 and 114 can be any type of computer system, including a personal laptop/desktop computer, tablet computer, cellular or other type of mobile device, network computer, server computer, and/or any other type of computing device that is configured to provide its user network access. For example, telepresence requestors 110, 112 and 114 can include a processing device such as a processor in communication with memory. The memory may include various types of cache, random access memory (RAM), or other high-speed dynamic storage devices via a local or system bus or other communication means for communicating data between such devices. The main memory can be capable of storing data as well as instructions to be executed by the processor and may be used to store temporary variables or other intermediate information during execution of instructions by the processor. Telepresence requestors 110, 112 and 114 can also comprise read only memory (ROM) and/or other static storage devices coupled to the local bus for storing static information and instructions for the processor. A system unit of the data processing system of each machine can also feature an expansion bus providing communication between various devices and devices attached to the system bus via the bus bridge. A removable data storage device, such as a DVD-RW, and its corresponding drive may be integrated into telepresence requestors 110, 112 and 114. Each of telepresence requestors 110, 112 and 114 can also include a display screen that respectively displays information to clients 118, 120 and 122. For example, the displays presented by telepresence requestors 110, 112 and 114 can include generated meeting package descriptions and associated images. An alphanumeric input device, including alphanumeric and other keys, may be coupled to the bus for communicating data and/or command selections to the processor. Another type of user input device is cursor control device, such as a conventional mouse, trackball, or touch interface (such as a mouse pad, multi-touch screen, etc.) for communicating direction information and command selection to the processor and for controlling cursor movement on the display.

In some embodiments, one or more of telepresence requestors 110, 112 and/or 114 can be implemented as a mobile phone or other highly portable device that has, e.g., internet browsing capabilities. Such a device does not necessarily include all of the devices and features of the above-described exemplary computer system; however, the functionality of the present invention or a subset thereof may nevertheless be implemented with such devices.

Telepresence requestors 110, 112 and 114 can also include a communication device that is coupled to the bus for accessing remote computers (such as each other), databases, servers, and mainframes, such as distribution system 102 and/or telepresence host system 104 via the Internet, for example. The communication device may include a modem, a network interface card, or other well-known interface devices, such as those used for interfacing with Ethernet, cellular network, satellite system, WAN, LAN, router and/or other types of network components. In any event, in this manner, telepresence requestors 110, 112 and 114 may be coupled to a number of networks 116.

Each of the machines can be configured to communicate with one or more databases via one or more database servers. Further to the discussion above, network 116 may include any type of wired and/or wireless coupling technology, such as through direct or dial-up telephone or other network transmission lines, cable modem(s), fiber optic cables, satellite system(s), cellular network(s), WAN(s), LAN(s), and/or through an additional network. For example, telepresence requestor 110, 112 and 114 can communicate with the database 102 from anywhere in the world via a link utilizing a cellular phone system, cable, Digital Subscriber Line, Integrated Services Digital Network, satellite connection, computer network (e.g. a wide area network (WAN), the Internet, or a local area network (LAN), etc.), or generally any sort of private or public telecommunication system, or combination thereof. Examples of a transport medium for the links include, but are not limited or restricted to electrical wire, optical fiber, cable including twisted pair, or wireless channels (e.g. radio frequency (RF), terrestrial, satellite, or any other wireless signaling methodology).

Network 116 can be a packetized, packet switched, any other type of network, or combination thereof, which can utilize, e.g., Internet Protocol (IP), Asynchronous Transfer Mode (ATM), Frame Relay (FR), Point-to-Point Protocol (PPP), Voice over Internet Protocol (VoIP), or any other sort of data protocol. Network 116 allows the communication of data traffic between the machines shown in FIGS. 1A and 1B as well as other machines (not shown). Data traffic through the network 116 may be of any type including text, graphics, video, e-mail, facsimile, multi-media, text, voice, audio, and/or any other generic forms of data. The network 116 may include a data network that may contain switching and/or other type(s) of routing equipment designed to transfer digital data traffic. It should be appreciated that the environment of FIGS. 1A and 1B is only exemplary and that embodiments of the present invention can be used with any type of communication system and/or computer network, protocols, and combinations thereof.

FIG. 3 shows exemplary components that may be included in telepresence host system 104 in accordance with embodiments wherein telepresence host system is implemented independent from computer reservation systems, such as distribution system 102. As noted above, telepresence host system 104 and/or its functionality may be optionally included in a computer reservation system, such as distribution system 102 (see, e.g., FIG. 2), and in such embodiments one or more of the components shown in FIG. 3 may be omitted from telepresence host system 104 to avoid unnecessary duplication of components.

Telepresence host system 104 can provide a capability to distribute and sell available time slots through, for example, distribution system 102′s connected point of sale (mySabre, GetThere, Travelocity Business, etc.). Distributing through distribution system 102 also has the added benefit that travel agents associated with distribution system 102 can promote availability of video conferencing at client's locations and time slots to small businesses that may be more likely to use the travel agents as a travel provider. This model may also be applicable to large travel management companies, who may also act as telepresence providers, that have a room where they can set up a video conferencing facility and rent the room and equipment by the hour through travel telepresence host system 104.

In the above exemplary scenarios, the provider of distribution system 102 is afforded the unique opportunity and potential benefits of being compensated by corporations, hotels and travel management companies, even when travel is abandoned in favor of a multimedia conference. This multi-faceted model, despite being facially counterintuitive, also reduces the dependence on cyclical demand patterns that are endemic to much of the travel industry.

In some embodiments, such as when telepresence host system 104 is implemented independent from any other computer reservation system, telepresence host system 104 may include processing circuitry 302 that may provide various means for implementing the functionality of telepresence host system 104. According to some example embodiments, processing circuitry 302 may include processor 304, which may be representative of a plurality of processors and/or other circuitry operating in concert.

Processor 304 may, but need not, include one or more accompanying digital signal processors. In some example embodiments, processor 304 is configured to execute instructions stored in memory device 306 or instructions otherwise accessible to the processor 304. Whether configured as hardware or via instructions stored on a computer-readable storage medium (such as memory device 306), or by a combination thereof, processor 304 may be an entity capable of performing actions according to embodiments of the present invention while configured accordingly. Thus, in example embodiments where processor 304 is embodied as an ASIC, FPGA, or the like, processor 304 is specifically configured circuitry hardware for conducting the actions described herein. Alternatively or additionally, in example embodiments where processor 304 is embodied as circuitry that executes of instructions stored on a computer-readable storage medium, the instructions specifically configure processor 304 to perform the algorithms and actions described herein. In some example embodiments, processor 304 is a processor of a specific device (e.g., telepresence host system 104) configured for employing example embodiments of the present invention by further configuration of processor 304 via executed instructions for performing the algorithms and actions described herein.

Memory device 306 may comprise one or more computer-readable storage media, such as volatile and/or non-volatile memory. Memory device 306 may be contrasted with a computer-readable transmission medium, such as a propagating signal. In some example embodiments, memory device 306 comprises random access memory (“RAM”) including dynamic and/or static RAM, on-chip or off-chip cache memory, and/or the like. Further, memory device 306 may comprise non-volatile memory, which may be embedded and/or removable, and may comprise, for example, read-only memory, flash memory, one or more magnetic storage devices (e.g., hard disks, floppy disk drives, magnetic tape, etc.), optical disc drives and/or media, non-volatile random access memory (NVRAM), and/or the like. Memory device 306 may comprise a cache area for temporary storage of data. In this regard, some or all of memory device 306 may be included within processing circuitry 208.

Further, memory device 306 may be configured to store information, data, applications, computer-readable program code instructions, or the like for enabling processing circuitry 302 to carry out various functions in accordance with example embodiments of the present invention described herein. For example, memory device 306 could be configured to buffer input data for processing by processor 304. Additionally, or alternatively, memory device 306 may be configured to store instructions for execution by processor 304.

Telepresence host system 104 can also include communications interface 308 in some embodiments. Communications interface 308 may be configured to facilitate communications between processing circuitry 302 and any type of external device, such as computer reservation systems (including global distribution systems, such as distribution system 102), client devices (such as telepresence requestors 110, 112 and/or 114), telepresence providers (such as telepresence providers 106 and/or 108), and/or any device connected to network 116. Like other components discussed herein, communications interface 308 may include any device or means embodied in hardware, a computer program product, or a combination of hardware and a computer program product that is configured to receive and/or transmit data from/to a network and/or any other device or module in communication with telepresence host system 104. Processing circuitry 302 may also be configured to receive and transmit information, including telepresence content, via communication interface 308 by, for example, controlling hardware included within the respective components. In this regard, communication interface 308 may comprise, for example, one or more antennas, a transmitter, a receiver, a transceiver and/or supporting hardware, comprising a processor for enabling communications. Via communication interface 214 and network 116, distribution system 102 may communicate with various other network entities, including telepresence requestors 110, 112 and 114, and/or receive various inputs in a device-to-device fashion and/or via indirect communications via a base station, access point, server, gateway, router, or the like.

Communications interface 308 may be configured to provide communications in accordance with any wired or wireless communication standard and/or communications technique. For example, communications interface 308 may be configured to communicate using techniques involving radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15 (BlueTooth®), and/or the like.

For example, telepresence host system 104 can use communications interface 308 to transmit data associated with the availability of resources configured to provide collaboration services at various telepresence providers, such as telepresence providers 106 and 108 (shown in FIGS. 1A and 1B). The data generated by telepresence host system 104 and/or other apparatuses of collaboration management system 100 (including other types of computer reservation systems) may be presented to a client as a webpage, such as those discussed in connection with FIGS. 4-6, 10A, 10B and 13.

Additionally or alternatively, as discussed further below, telepresence host system 104 can interface with a Microsoft Exchange server and/or other third party equipment, and be configured to present a client data in a form native to the third party equipment.

Further to the above discussion, telepresence host system 104 may serve as a reservation system that tracks the availability of telepresence equipment in real time by, e.g., receiving updates as the availability changes (e.g., having telepresence providers 106 and/or 108 push new information to telepresence host system 104 in response to a change occurring). Additionally or alternatively, telepresence host system 104 may serve as a reservation system that tracks the availability of telepresence equipment in near real time by, e.g., periodically receiving availability updates (e.g., every few seconds, minutes, hours, or any other predetermined time period) from telepresence providers 106 and/or 108. Upon receiving a message containing an availability update, processing circuitry 302 may be configured to provide the availability content to availability processor 310, which may be configured to process and monitor the availability of the equipment associated with one or more telepresence providers. Processing circuitry 302 and/or availability processor 310 may also be configured to store the availability information in local database 312 and/or an external database. Database 312 may be any type of storage device, similar to the other storage devices discussed herein, and may be distinguished from a transitory data signal.

For example, telepresence host system 104 can provide real time or near real time availability for a telepresence room associated with a telepresence provider in response to receiving a request from a client device, such as telepresence requestors 110, 112 and/or 114. The availability of a telepresence provider's equipment may be based on how the owner(s), operator(s) and/or other third parties choose to configure their systems to send data to telepresence host system 104. For example, Company A associated with telepresence provider 106 may not want telepresence host system 104 interrogating telepresence provider 106 every four seconds (which may be a default value) for availability and instead opt for an alternative update frequency range of every 104 to 120 seconds.

Also, in some embodiments, telepresence host system 104 can act as the system of record for a telepresence provider. For example, Company B may own and/or operate 20-30 public telepresence rooms. Company B may choose to have telepresence host system 104 connect to their internal system for managing availability of these rooms and act as a bridge to the public. In this manner, telepresence host system 104 may book one or more of Company B's rooms. This may include, for example, telepresence host system 104 receiving payment from clients to use one or more of Company B's rooms, update the rooms availability in database 312, notify Company B's systems of the booking, and/or provide any other services to the clients (such as interface with other components to book travel arrangements, if necessary).

Additionally or alternatively, rather than manage some or all of its systems availability, Company B may elect to have telepresence host system 104 be the system of record solely responsible for managing the availability of Company B's telepresence rooms and/or equipment. To provide this service to Company B, telepresence host system 104 may be configured to have Company B migrate their systems' availability to telepresence host system 104, where the availability information may be managed by, for example, availability processor 310 and stored in database 312. In some embodiments, telepresence host system 104 may charge a fee (subscription, upfront, and/or any other type of fee) to be the system of record for Company B. The fee may be reduced or otherwise based on Company B's other business relations and/or agreements (such as an agreement to use one or more computer reservation systems associated with telepresence host system 104 to book physical travel arrangements).

As mentioned above, client may use telepresence requestors 110, 112, and 114 to telepresence content from telepresence host system 104. In addition to telepresence provider availability, “telepresence content” as used herein may include business rules, prices, locations, type identifiers (e.g., identifying the type of telepresence equipment), compatibility identifiers (e.g., identifying the compatibility of telepresence equipment), and/or other data that may aid in reserving a telepresence conference.

Business rules processor 314 may generate, maintain and/or otherwise manage one or more business rules. The business rules may be stored in database 312. In some embodiments, business rules processor 314 may have direct connection to database 312 (not shown).

As used herein, business rules include information that may define and/or constrain some aspect of the service provided by telepresence host system 104. For example, business rules processor 314 may be configured to cause telepresence host system 104 to consider the business structure and/or relationships associated with telepresence requestors 110, 112, and 114. In addition to or instead of being associated with computing systems (such as telepresence requestors 110, 112, and 114), the business rules may be specific to people, processes, corporate behaviors, among other things, and may be created to aid telepresence host system 104 in providing client-specific functionality. For example, a business rule may include the frequency at which telepresence host system 104 pulls availability and/or other information from telepresence providers 106 and 108. Business rules processor 314 may also be used by processing circuitry 302 to customize responses to requests from one or more clients (e.g., certain clients may need to pay at time of scheduling, while other clients may have prepaid).

Although not shown in FIG. 2 or the other drawings, business rules that are unrelated to telepresence events may also or instead be maintained by collaboration management system 100. For example, a business rule may be generated that requires management system 100 to consider the cost of charter aviation and/or private aviation (e.g., corporate jet) options along with telepresence options and traditional commercial travel options. In some embodiments, such options may be restricted. For example, private aviation options may only be considered for particular people, business titles, and/or positions within a company. The timing of a meeting may also be considered when determining whether or not to offer options, such as private aviation options.

Business rules may also be configured to enable telepresence host system to be compatible and integrated with other common collaboration tools used at many corporations, such as Microsoft SharePoint® and/or the native scheduling resource capabilities included in the various Microsoft Exchange® platforms. For example, business rules may be established that allow clients to leverage standard Microsoft Exchange 2010 federation functionality. Business rules can also be set for a group to have the right level of permissions and then be used to facilitate communication between the attendees without having to resort to email when organizing (e.g., confirming scheduling for) the meeting. In other embodiments, a trip-specific webpage (such as a .NET service oriented architecture) may be used to provide notifications via email when any member of the group updates the telepresence reservations. The webpage may be set up by telepresence host system 104 in response to determining, for example, at least one of the clients may be using a legacy Exchange® environment. In this regard, business rules may be created to provide the following core capabilities—group setup, permissibility restrictions (e.g., security), a webpage to store comments and plan data, alerts to a mobile and/or other network devices when any changes are made by any member of the group to the web page, among other things. This may enable the providers of telepresence host system 104 to avoid paying integration fees to third party providers, while also making the collaboration tool travel centric thereby improving efficiencies and usability.

In providing travel and telepresence meeting reservations, telepresence host system 104 may enable clients, including corporate clients, to make a selection based on their preferred suppliers, which may be stored in a client's profile. The client's profile may be managed by business rules processor 314 and comprise a collection of business rules. In addition to preferences of air and hotel providers, clients may also be given the opportunity to associate a preference for video conferencing and other telepresence providers in their profile maintained by business rules processor 314.

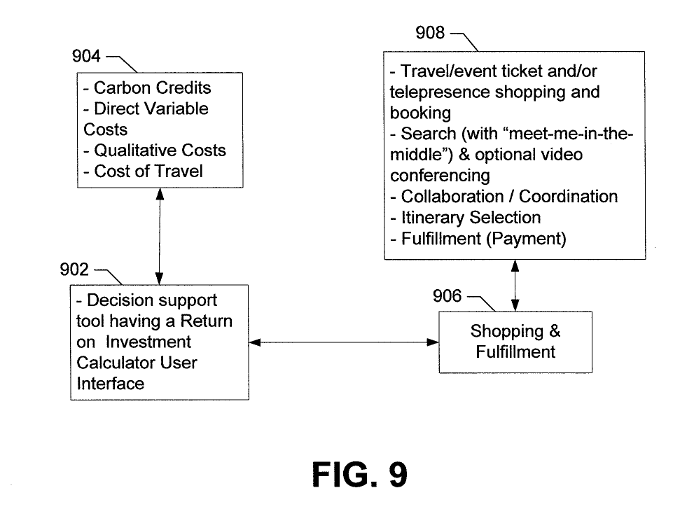

Rate processor 316 may be configured to determine the price to use telepresence equipment. In some embodiments, such as when telepresence equipment is provided to the requesting client free of charge (e.g., because the telepresence equipment is owned by the requesting client's employer), the rate processor may generate data that may be inputted into a return on investment calculator to establish a relative cost of conducting a telepresence meeting. The return on investment calculator is discussed below in connection with, e.g., FIGS. 9-12. In embodiments where the client is to pay for services provided by telepresence host system 104 and/or telepresence providers (such as telepresence providers 106 and 108), rate processor 316 may be configured to generate the amount owed by the client. The amount owed may be affected based on, for example, business relationships that may be managed by business rules processor 314.

In some embodiments, telepresence host system 104 can be telepresence provider agnostic, thereby working with any and/or all types of collaboration technology services, tools, equipment, software, among other things. To help maintain which telepresence provider may be used with other telepresence providers, telepresence host system 104 may include system compatibility processor 318, which may be configured to enable telepresence host system 104 to schedule telepresence conferences between telepresence providers that have compatible equipment, even though telepresence host system 104 may be configured to also manage non-compatible equipment. For example, although Cisco Systems, Inc.'s TelePresence® systems may not be compatible with and Hewlett-Packard's Halo® systems, telepresence host system 104 may be configured to manage the availability and booking of both types of systems. System compatibility processor 318 may be used to manage which systems are compatible and cause the booking of telepresence providers for a collaboration event to include compatible systems.

User interface 320 may be in communication with processing circuitry 202 to receive user input(s) from, for example, a system administrator. For example, user interface 320 may include hardware, software and/or firmware for a keyboard, mouse, track pad, multi-touch screen, microphone, camera, and/or any other input component with which user 322 may interact and set up some or all of the predefined functionality of telepresence host system 104. User interface 320 may also be configured to present output to user 322. For example, user interface 320 may include hardware, software and/or firmware for a display (e.g., a touch screen display), a speaker, and/or any other type of audible, visual, mechanical (including tactile) that can provide output indications, such as a list of the current business rules, to user 322.

In this regard, from the client's prospective, telepresence service and equipment reservations can be booked through some embodiments of collaboration management system 100 in a manner that is familiar to the client, because it is similar to how air and hotel reservations can be booked currently. An infrastructure, such as that of collaboration management system 100 shown in FIGS. 1-3 can be provided that communicates with telepresence providers and telepresence requestors to receive availability by date, time slot and the associated rate that is always current. For example, third party partners that design and distribute telepresence systems and services, such as Cisco Systems and Hewlett-Packard, may configure their systems to post an open/close message (which may be XML based or teletype) to telepresence host system every time there is a change—booking (close message) or cancellation (open message)—for a time slot at a telepresence provider. As another example, the telepresence providers may provide the current booking information to telepresence host system 104.

For all video conference providers that distribute through telepresence host system 104, telepresence host system 104 can serve as the system of record for inventory status (availability) and pricing by time slot (day-part). This may allow all suppliers to provide automated up-to-date status on availability and prices in real time or near real time.

Telepresence host system 104 may also include a payment solution to receive payment from a telepresence requestor and send payment to a telepresence provider (if, e.g., the telepresence requestor is not the same corporation or other entity that controls access to the telepresence provider equipment). In some embodiments, telepresence host system 104 may also receive a fee for providing the facilities to organize the telepresence event.

Some embodiments can also include specialized sales tools (examples of which are discussed below) for the sales organization of a corporation. The sales tool can receive as inputs the pertinent parameters specifically developed to determine the trade offs and probability of closing a deal (potential revenue or potential revenue retention in the case of renewals) against the cost of travel and relationship/goodwill costs.

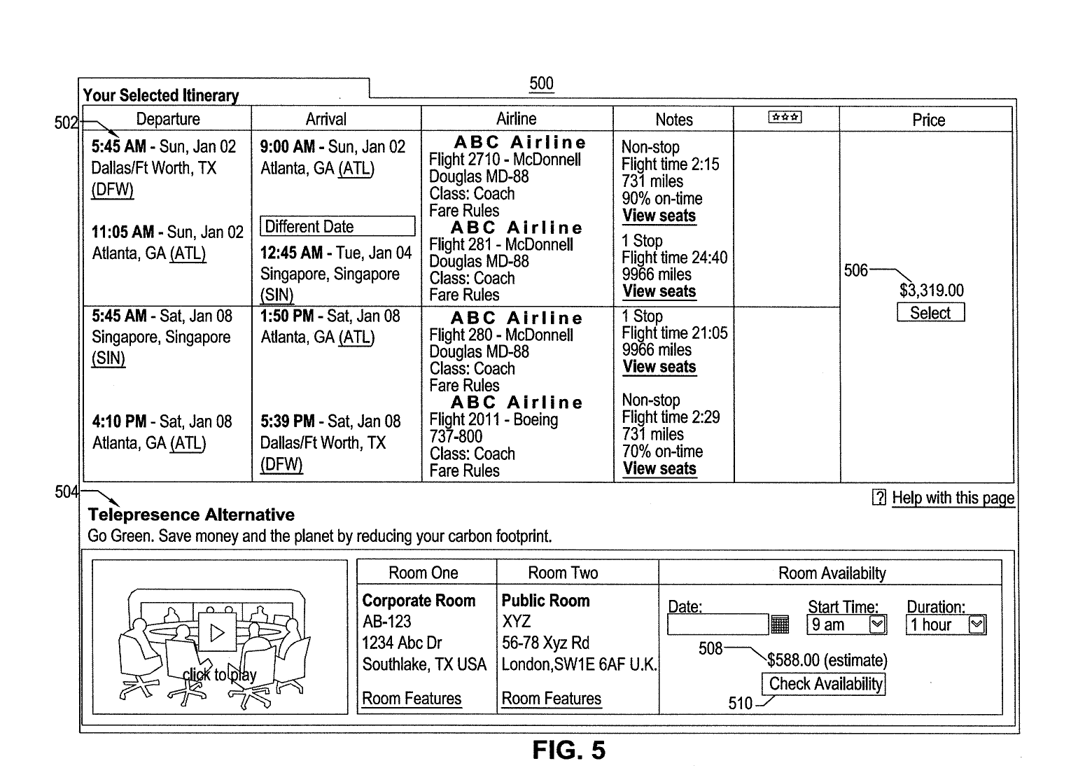

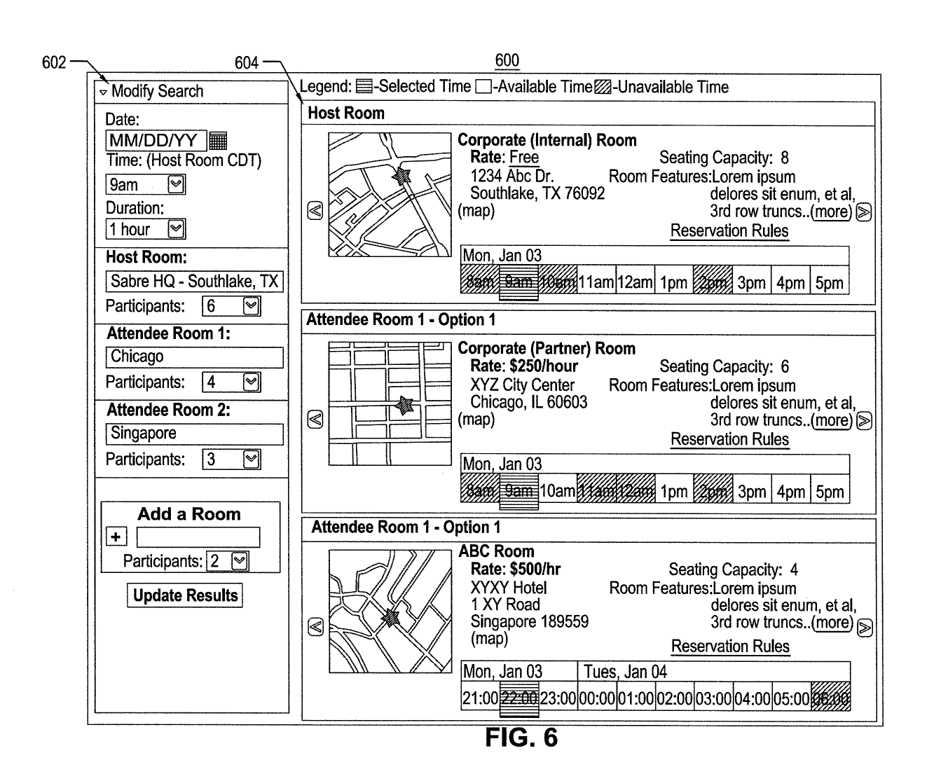

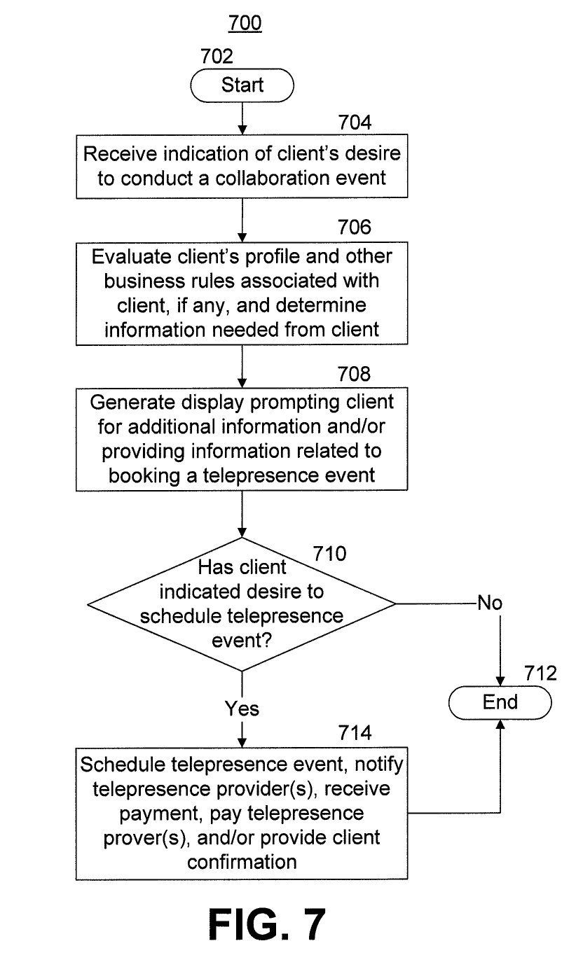

The functionality provided by some embodiments to book (e.g., reserve and/or pay for) the use of telepresence equipment may be coupled with various other features, functionality and systems, some of which are discussed below. For example, a client may be provided an intranet website that allows the client to book telepresence equipment (discussed in connection with, e.g., FIG. 4), a telepresence advertisement may be provided when booking physical travel (discussed in connection with, e.g., FIG. 5), data may be compiled and presented that show the availability of one or more telepresence providers (discussed in connection with, e.g., FIG. 6), a confirmation message may be provided to the client after booking a telepresence meeting (discussed in connection with, e.g., FIG. 7), and a return on investment calculator with various displays may also be provided to the client.

### Booking Telepresence Services

Many different types of collaboration may benefit from embodiments of the present invention. For the sake of simplicity, the following examples are generally focused on how some embodiments can be utilized to enhance the type of business meetings that historically required one or more individuals to physically travel to a specific destination to meet with colleagues and conduct business.

FIG. 4 shows display 400 that may be, for example, a website provided to an employee to book telepresence services. Display 400 may be generated by telepresence host system 104 and/or any other component of collaboration management system 100 in response to a telepresence requestor apparatus sending a message that indicates a desire to book a collaboration event. In some embodiments, display 400 may be the default display in response to an employee indicating a desire to schedule a long-distance meeting or other type of collaboration event.

Display 400 may include a number of fields and/or other display elements that may indicate the types of information collaboration management system 100 may need from the employee or other type of user. For example, in response to an employee selecting “internal meeting” from options menu 402, a number of collaboration options may be presented. For example, display 400 may provide in-office option 410, video conference option 412, and physical travel option 414. The number and types of collaboration options that are included in display 400 may depend on a number of variables, including employee title/seniority (e.g., more senior employees may be presented a travel option without needing manger's approval), the purpose of the meeting selected from options menu 402, the locally available equipment based on data entered into field 416 and field 418 (e.g., telepresence host system may determine there is a lack of video conference capabilities in at least one of the party's locations and not include conference option 412 in display 400), the availability of equipment based on time entered into section 420, and/or any other variable that may be considered by collaboration management system 100 when generating display 400. As shown in FIG. 4, video conference option 412 may include one or more room options 422 for various video conference rooms at one or more of the locations specified in fields 416 and/or 418. Room options 422 may include options that collaboration management system 100 had determined are compatible with each other. Other information, such as maps 424 and 426 may be included to show where the telepresence providers are located in each respective city.

FIG. 5 shows display 500 that may be, for example, another website used to facilitate the booking of telepresence services. Display 500 may be generated by telepresence host system 104 and/or any other component of collaboration management system 100 when a telepresence requestor apparatus is booking a collaboration event that involves physical travel. In some embodiments, display 500 may be presented, for example, after an employee has received manager's approval or has otherwise selected option 414 of display 400. Display 500 may also be presented to more senior and/or other types of employees who are allowed to physically travel if they so choose.

Display 500 is shown as including at least two portions, namely physical travel arrangements portion 502 and telepresence alternative portion 504. In some embodiments, the data included in telepresence alternative portion 504 may be customized based on the travel information the client provided to obtain price quote 506 in physical travel arrangements portion 502 (e.g., dates of travel, departure city, destination city, dates, etc.). The customization of telepresence alternative portion 504 may allow a client to quickly compare price quote 506 with price estimate 508. An opportunity assessment collaboration calculator module can be used to generate a “what-if” analysis tool for end users to make an informed decision about a potential trip for an internal corporate meeting. If the client would like to get a more detailed price quote to conduct a telepresence event instead of or in addition to a travel event, the client may select option 510. In response to selecting option 510, collaboration management system may determine that additional information is desired from the client and provide a display that requests the desired information. Alternative portion 504, like other user interface components discussed herein, may be included in any other type of display and/or presented in any manner that the client may understand.

FIG. 6 shows display 600, which is an example of a display that may be presented in response to option 510 being selected by a client. Display 600 may be presented in response to another option of another display (such as go button 428 of FIG. 4). Alternatively, display 600 may be the default display provided by telepresence host system 104 in response to receiving a request from a telepresence requestor to book a telepresence event.

Display 600 may include at least two main sections, portion 602 and portion 604. Portion 602 may include a number of options that allows a client to indicate, for example, times, locations, number of attendees (e.g., size of the desired telepresence room), and/or other information that may allow telepresence host system 104 to generate the information presented in portion 604.

Portion 604 may include, for example, various telepresence providers, the availability of the telepresence rooms, the rates associated therewith, features provided by the telepresence provider, links to additional information, and/or any other information that may be of interest to the client when booking a telepresence event using collaboration management system 100. The available times may be selected by the client and, in response to receiving the client's selection, collaboration management system 100 may present a payment display (not shown) that asks for payment information (e.g., account information, etc.), deducts the purchase price from the client's account (if known), and/or executes any other booking functionality required to reserve the telepresence provider's room for the client. For example, in some embodiments, telepresence host system may inform the telepresence provider of the booking, which may or may not cause the telepresence provider to update its own internal system that tracks its equipments' availability.

A telepresence confirmation display (not shown) may then be presented to the client, emailed to the client, and/or otherwise provided to the client. The telepresence confirmation display may be similar to those used for travel arrangements. For example, the telepresence confirmation display may provide a confirmation number generated by telepresence host system 104, the room number that has been reserved, the cost, a payment receipt, and/or any other information in which the client may be interested.

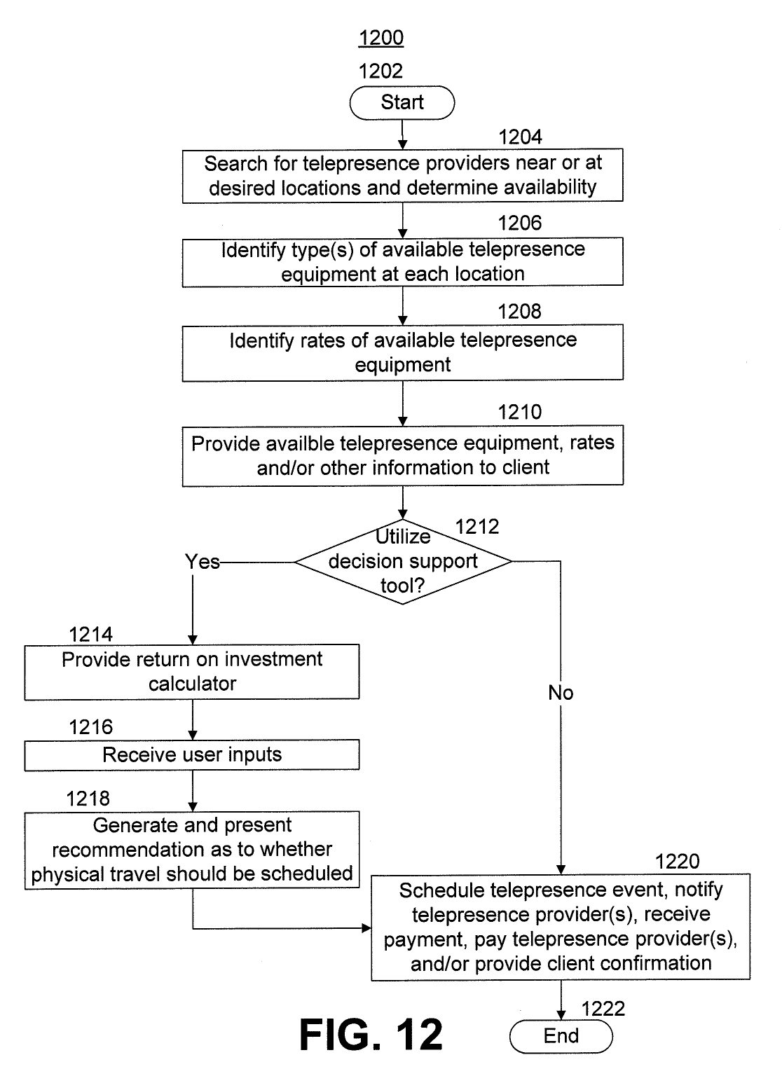

FIG. 7 shows a flow diagram in accordance with some exemplary methods, computer program products and/or systems discussed herein, including those discussed in reference to in FIGS. 1-3. It will be understood that each action, step and/or other types of functions shown in the diagrams, and/or combinations of functions in the diagrams, can be implemented by various means. Means for implementing the functions of the flow diagrams, combinations of the actions in the diagrams, and/or other functionality of example embodiments of the present invention described herein may include hardware, and/or a computer program product including a computer-readable storage medium (as opposed to or in addition to a computer-readable transmission medium) having one or more computer program code instructions, program instructions, or executable computer-readable program code instructions stored therein. In this regard, program code instructions may be stored on a storage device of an example apparatus and executed by a processor, such as the processing circuitry discussed above. As will be appreciated, any such program code instructions may be loaded onto a computer or other programmable apparatus (e.g., processing circuitry 208, processing circuitry 302, or the like) from a computer-readable storage medium (e.g., storage device 212, storage device 306, or the like) to produce a particular machine, such that the particular machine becomes a means for implementing the functions specified in the diagrams' actions shown in FIG. 7 as well as FIG. 12 discussed below.

These program code instructions may also be stored in a computer-readable storage medium that can direct a computer, a processor (such as the processing circuitry discussed above), or other programmable apparatus to function in a particular manner to thereby generate a particular machine and/or particular article of manufacture. The article of manufacture becomes a means for implementing the functions specified in the diagrams' actions. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provides actions for implementing the functions specified in the diagrams' actions.

Process 700 starts at 702. At 704, telepresence host system 104 may receive an indication of a client's desire to conduct a collaboration event. For example, in response to the client selecting an option presented by one or more of displays 400, 500 and/or 600, a component of collaboration system 100 (e.g., distribution system 100 and/or telepresence requestor) may generate a message and/or other type of signal that is sent to telepresence host system 104. For example, in response to the client indicating a desire to book physical travel arrangements, distribution system 102 may be configured to automatically query telepresence host system 104 and present a telepresence alternative option, such as that discussed in reference to FIG. 5.

At 706, telepresence host system 104 may evaluate the profile and/or other business rules associated with the client. A client identifier (such as a polygon identifier, user name, and/or any other type of identifying data) may be included in and/or otherwise associated with the signal received by telepresence host system 104. The client identifier can be used to retrieve any business rules associated with the client from database 312 and/or elsewhere.

A determination may also be made at 706 as to whether or not additional information is needed from the client. For example, telepresence host system 104 may determine that it needs to know how many people may be involved in a telepresence event, which may impact the size of the room to be booked.

At 708, telepresence host system 104 may transmit a signal to the client device that causes the client device to generate a display prompting the client for additional information and/or providing information related to booking a telepresence event. For example, the availability and/or rate (which may be corporate rate based on retrieved business rules) may be presented to the client. The additional information needed from the client may also include, for example, a question as to whether or not the client would like to book a telepresence event.

At 710, a determination is made as to whether or not the client has indicated a desire to schedule a telepresence event. In response to determining that the client has not indicated a desire to schedule a telepresence event, process 700 may proceed to 712 and end.

In response to determining that the client has indicated to schedule a telepresence event, process 700 may proceed to 714. Telepresence host system 104 may facilitate the scheduling of the desired telepresence event at 714. In some embodiments, telepresence host system 104 may also notify the telepresence provider(s) that will be involved in the telepresence event. For example, telepresence host system 104 may automatically generate and transmit an email to the telepresence providers. Telepresence host system 104 may also receive payment as part of the scheduling process. In other embodiments, payment may not be required (e.g., because the telepresence providers is owned, operated, and/or otherwise associated with the client such that the client need not pay to use the telepresence equipment for at least the particular event). In some embodiments, telepresence host system 104 may collect a fee, regardless of whether or not telepresence provider collects a fee. The client and/or the telepresence provider may the fee to telepresence host system 104. Additionally or alternatively, telepresence host system 104 and/or any other component of collaboration system 100 may provide a confirmation message to the client. The confirmation message may include various details the client may need and/or be interested in regarding the scheduled telepresence event.

### Booking Telepresence Services with Physical Travel

In some embodiments, rather than or in addition to offering a telepresence event as an alternative to physical travel, collaboration management system may offer a telepresence event in addition to physical travel. For example, it may be more cost effective to collaborate in-person in two locations with a telepresence bridge between the two locations (sometimes referred to herein as “nodes” of the telepresence bridge), rather than have all parties travel to a single location. Similarly, it may be more productive to have all parties in two physical locations than to have people collaborate from a plurality of locations.

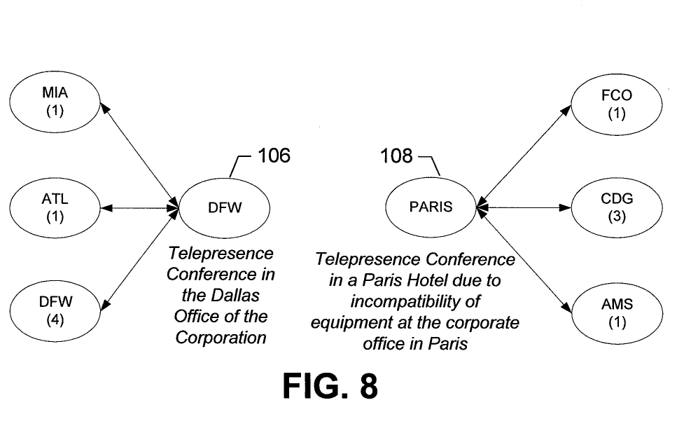

In this regard, FIG. 8 shows a “meet-in-the-middle” approach, wherein telepresence providers 106 and 108 in Dallas and Paris, respectively, are leveraged to increase productivity and reduce travel expenses of the client(s). A number of telepresence requestors, similar to or the same as telepresence requestors 110, 112, and 114, may be located in Miami (“MIA”), Atlanta (“ATL”), Dallas (“DFW”), Rome (“FCO”), Paris (“CDG”) and Amsterdam (“AMS”).

To avoid transatlantic travel and the costs associated therewith, individuals from Miami, Atlanta and Dallas may fly to Dallas (preferred since there are four attendees from Dallas while Atlanta and Miami each have one) and use telepresence provider 106 in the client's Dallas corporate office. Similarly individuals from the client's European offices may congregate in Paris (since there are three attendees from the Paris office, while the other two locations have one each) and use telepresence provider 108. This arrangement may be presented as an option by some embodiments.

In some embodiments, in addition to or rather than basing the travel itineraries on the number of attendees coming from each location, the system can generate and present a recommendation on a location for nodes of the telepresence bridge based on a determination of the cost of airfare and hotel for each individual. In addition, collaboration management system 100 may suggest and schedule the location for the video conference to take place in Paris at a hotel (instead of the corporate office in Paris). For example, collaboration management system 100 may choose the Paris hotel in response to collaboration management system 100 determining that the multimedia equipment at the Paris office is not compatible with telepresence provider 106 in the Dallas office. The selection of the specific hotel location can be based on, for example, the rate and any location preferences provided by the attendees in the collaboration planning tool on the webpage shown above.

As part of the trip planning process, the default mechanism for arriving at a decision on “DFW” and “PARIS” (in the example above and shown in FIG. 8) can be based on collaboration between the participants. In some embodiments, such as for North American or other content-specific travel, a different set of defaults can be programmed into collaboration management system 100 (e.g., as business rules stored in and managed by telepresence host system 104). For example, collaboration management system 100 can be configured to determine and leverage the estimated or actual seat value, which can be used to schedule U.S.-domestic air reservations, to evaluate all permutations (e.g., DFW compared to ATL compared to MIA) relatively quickly, and provide a recommendation for the least expensive option from an air travel cost perspective. In some embodiments, the estimated seat values can be pre-computed and stored in distribution system 102′s memory and/or telepresence host system 102′s memory to be accessed during the user-specific planning process.

Also, in some embodiments, estimated seat values can be used to recommend one or more cities that are the least expensive for at least some of the participants to meet. For example, if the participants are based in LAX, SFO, NYC and PHL, estimated seat values can be used to recommend LAX or OMA as the “optimal low cost city” from an air travel and/or other cost perspective for the attendees to meet with or without resorting to the video conferencing option.

### Decision Support Tool and Return on Investment Calculator

In some embodiments, during the planning phase of a potential trip, regardless of whether the planning is for an individual or group of individuals, collaboration management system 100 may be configured to function as a decision support tool at 902. For example, processing circuitry 302 of telepresence host system 104 may be configured to receive various inputs, such as those shown at 904 to enable various types of shopping and fulfillment at 906. Collaboration management system 100 data may also be configured to log data, create an audit trail, and prepare reports based upon the inputs selected at 904 for the shopping and fulfillment at 906. Examples of the types of shopping and fulfillment that may be executed are shown at 908, and an example of a shopping and fulfillment process for booking a telepresence event is discussed in reference to, e.g., in FIG. 7.

As a decision support tool, telepresence host system 104 may be configured to provide a travel opportunity assessment collaboration calculator to a client. The decision support tool can be used to execute a “what-if” analysis and provide data to allow end users to make an informed decision about a potential trip for an internal corporate meeting and/or other type of meeting. For example, the decision support tool can help the user determine the potential return on an investment made in physically traveling to conduct a meeting in person, versus the cost (tangible and intangible) of conducting a telepresence meeting from a distance, or a combination thereof.

Accordingly, some embodiments of the present invention can be used to plan workflow along multiple dimensions to promote efficient travel. The decision support tool functionality of telepresence host system 104 may comprise a specialized collaboration calculator module, which may be implemented by the circuitry of telepresence host system 104 discussed herein (see the discussion in reference to, e.g., FIG. 3). The decision support tool may provide decision support capability to corporations for reducing travel spending by, e.g., evaluating each travel request and determining an expected return on the investment (cost of the travel). This can be made available to all or specific connected points of sale (such as, e.g., authorized travel agents and/or certain clients). Business rules stored and managed by telepresence host system 104, for example, can indicate whether or not decision support tool should be made available and/or downloaded to a client device at 902.

While corporations and/or other clients may use the business support tool to reduce travel costs, the maintainer of telepresence host system 104 can be compensated in exchange for providing the business support tool (and/or any other service discussed herein). For example, a fee may be required by telepresence host system 104 to provide decision support tool at 902 to one or more clients. As another example, clients using services and resources provided by telepresence host system 104 can be charged an annual access fee for all the services performed by telepresence host system 104 (and/or any other aspect(s) of collaboration management system 100). As yet another example, clients that go through travel agents can be charged a fee per request, regardless of whether travel or telepresence resources are booked or not. If travel or a multimedia meeting is averted, the fee could be adjusted (e.g., lower or higher) compared to when the booking was made.

The decision support tool can be utilized by a client for a number of scenarios, some of which are shown at 908. For example, the decision support tool can be utilized when booking travel at 906 without booking a multimedia conference. The workflow currently used for airline ticket shopping can be enhanced significantly by using the decision support tool to determine that a face-to-face meeting is required and multimedia conferencing may be less valuable or may be a less productive option. As another example, the decision support tool can be configured to recommend a “meet-me-in-the-middle” meeting (discussed above) in situations when it is cheaper to do so than the more traditional itinerary. The decision support tool can also or instead be utilized when booking travel with multimedia conferencing.

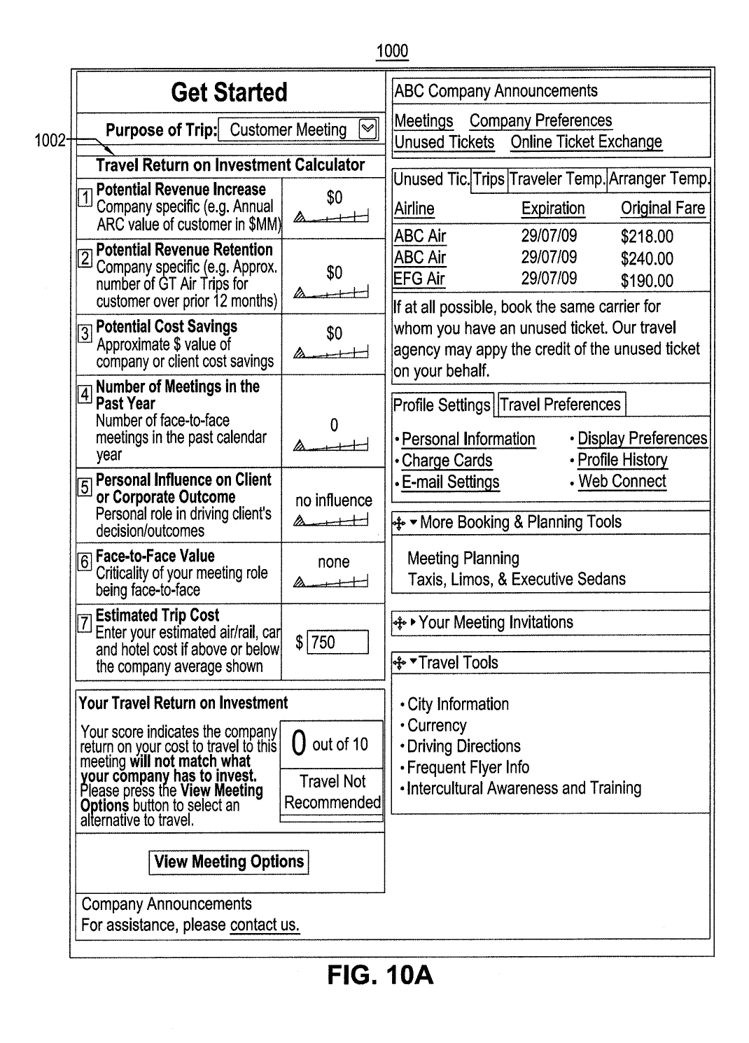

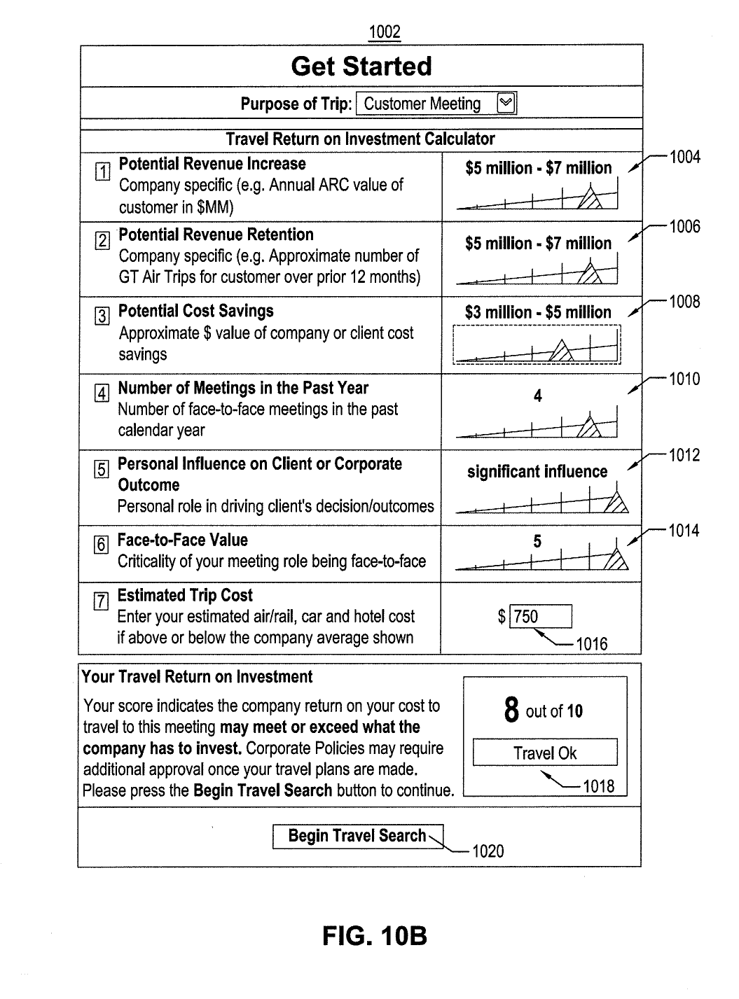

In some embodiments, although the decision support tool functionality is discussed in connection with telepresence host system 104, the decision support tool can be provided using software and/or the hardware discussed above in connection with any of FIGS. 1-3, and at least the user interface of the decision support tool functionality can be accessed from various points of sale (at, e.g., telepresence requestors 110, 112, and 114) to determine the return on investment for a company's expenditure on a given trip, meeting or other type of business collaboration. The resulting score outputted by the decision support tool (discussed below in reference to FIGS. 10A and 10B), sometimes referred to herein as the return on investment calculation, can be taken from a combination of end-user inputs, static and variable corporate content, and/or static and variable back end calculations, among other things.

In addition, other variables, such as variables shown at 904 can be received as one or more inputs for some embodiments of the decision support tool. The variables of 904 may become more important and/or appended for making future decisions. For example, as part of an audit trail, embodiments of the decision support tool can be configured to consider, track and accumulate carbon credits associated with each corporate account and, in addition to or instead of factoring the value of the carbon credits, also provide the value of the carbon credits as part of the corporation's monthly reporting. The decision support tool's method for accounting for the reduction in CO₂ emissions can comprise, for example, the model developed by Sabre Airline Solutions Consulting. Using this model, the decision support tool can factor in the value of carbon credits and create an audit trail of accumulated carbon credits saved and/or spent, which may subsequently be used by a reporting function of a corporation. In addition to carbon credits, 904 shows some exemplary inputs to the decision support tool, including direct variable costs, qualitative costs, and/or costs of travel, among other things.

FIGS. 10A and 10B show how these inputs may be weighted by a client to execute the potential return on investment calculation when planning a collaboration event at 906. As such, both qualitative and quantitative measures can be considered as inputs during the evaluation process performed by the decision support tool.

For example, a client using telepresence requestors 110, 112 and/or 114 can provide user-specific qualitative measure inputs using display 100 shown in FIG. 10A. Display 100 may include a point-of-sale interface that can be used to facilitate user-entered data to the decision support tool. The human interface of decision support tool 902 is shown as a “travel return on investment calculator” shown in portion 1002 of FIG. 10A. As shown in FIG. 10A, portion 1002 can appear in an online travel workflow and/or an offline travel workflow generated by a global distribution system (such as distribution system 102), telepresence host system 104, and/or other client service representative computer application (such as those that can be implemented by one or more components of collaboration management system 100).

FIG. 10B shows only portion 1002 to underscore that portion 1002 may be included in any type of display presented by any type of machine. For example, the travel return on investment calculator can be accessed by the user(s) at telepresence requestors 110, 112 and/or 114 to determine the preferred collaboration method for a given business meeting.

Some examples of qualitative measure inputs that may be provided by the user are shown in FIG. 10B. The shown examples include slide bars 1004, 1006, 1008, 1010, 1012, and 1014, which the user may move to the left or right to provide qualitative measure inputs. For example, slide bar 1004 may be used to input the potential revenue increase, slide bar 1006 may be used to input the potential revenue retention, slide bar 1008 may be used to input the potential cost savings, slide bar 1010 may be used to input the number of meetings in the past year that were conducted face-to-face, slide bar 1012 may be used to input the personal influence on client and/or potential corporate outcome, and slide bar 1014 may be used to input the face-to-face value.

In some embodiments, the user may also enter the estimated trip cost to conduct the face-to-face meeting into box 1016. The estimated and/or known travel costs can be factored into the determination as to whether a telepresence event should be scheduled instead of or in addition to a travel event. Travel costs may include costs for airfare, hotel, ground transportation, and/or incidentals. As a first example, some embodiments of telepresence host system 104 and/or any other aspect of collaboration management system 100 may include a travel cost calculator module that is configured to calculate the cost to travel to a destination, in the absence of using a video conferencing facility, to facilitate the meeting. In addition to or instead of airfare and hotel costs, the travel cost calculator module can be configured to integrate one or more corporate expense reporter tools for estimates of cost of taxi and other modes of transportation. As another example, the travel cost calculator module can be configured to consider the cost to travel to a middle destination (a partial trip, or a meet-in-the-middle telepresence event) for a group that schedules to use a video conferencing facility to conduct business.

Each of the quality measure inputs can take any form, such as a dollar amount, number on a graduated scale (e.g., 1 to 10) and/or an importance value (high, medium, low), which can then be calibrated collectively (or with other variables) to estimate a dollar impact. FIG. 10B shows an example of a web interface after the estimated dollar impact has been generated by, e.g., distribution system 102, and returned to the requesting machine in output 1018. Although slide bars and a data entry box are included in the travel return on investment calculator shown in FIGS. 10A and 10B, any other type of input component may be used to receive qualitative measure inputs.

Also, in some embodiments, additional or alternative qualitative measure(s) (not shown) may be inputted by a user and used by the system to determine the return on investment provided at output 1018. For example, some embodiments can also be configured to account for various types of trip-specific details. A surcharge (such as the European Union surcharge for carbon credits) may vary by country. Hence, the travel path may need to be enhanced or at least considered when determining the travel return on investment to influence and/or display options for itineraries that minimize these surcharges.

In some embodiments, Satty's analytic hierarchy process can be used by the decision support tool to arrive at output 1018. For example, all participants in a meeting may be provided a standard questionnaire to be completed. The questionnaire may be similar to or the same as the travel return on investment calculator shown in FIGS. 10A and 10B. The questionnaire may be related to internal meetings and analytic hierarchy process can then be used to arrive at the weights (importance) of each category included in the return on investment calculator and then translate this into a dollar value. Regardless of the approach taken (analytic hierarchy process and/or an alternate method), calibrating the qualitative measures to arrive at a dollar value may be a difficult process and is likely to be subject to a debate on how well it reflects reality. The dollar value component (like any other feature discussed herein) can be an optional feature. In addition, the dollar value of the qualitative measure can be displayed as part of the evaluation's output shown at 1018, but can be considered in the return on investment calculation for the planned trip strictly as an option by the user.

A user using telepresence requestors 110, 112 and/or 114 can also provide user-specific variable cost inputs. Components of the total variable costs can include, for example, video conferencing room costs per hour, telecommunication costs per hour, amortized cost per hour of the video conferencing equipment based on expected utilization over the technological life of the equipment, and productivity impact of the team that is brought together for this meeting. Travel time may also be included in the calculation as it often subtracts productive time from the office due to, e.g., waits at airports and time spent on airplanes (block time). Some embodiments discussed herein can measure the impact on productivity based on, e.g., the average hourly rate of the employee (which may be the fully allocated cost) multiplied by the total time for travel (which may limit daily hours to an eight-hour workday) for the duration of the trip minus the time spent in meetings.

As mentioned above, these (and other) qualitative and/or quantitative measures can then be encapsulated into a trade-off analysis against the cost of travel (including, e.g., airfare, hotel, rental car, incidentals, etc.) as shown in FIG. 10B. The evaluation can be configured to work for an individual and/or a group of individuals who plan to travel for the business meeting.

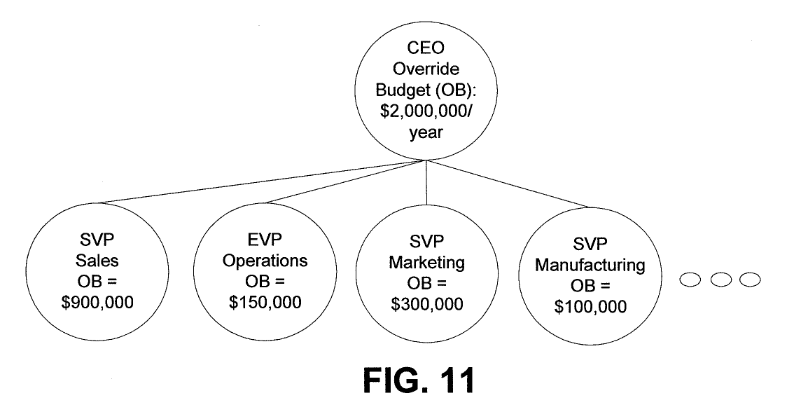

In some embodiments, the decision support tool can also be configured to consider corporate budgets in generating output 1018. As shown in FIG. 11, budgets can be established at different levels in an organization and/or for a project. The budget amount for each level may be established at the end of the prior year as part of the budget planning process. The expected spend amount estimated by the return on investment calculator of the decision support tool can be compared to the remaining spend available from the budget. If funds are available, the normally weighted approval process discussed above may apply. If there is little or no budget remaining, a more rigorous approval workflow may be used by the decision support tool. For example, in response to determining that the associated travel budget has been exceeded and is operating in the override budget, a more heavy weighting can be given to one or more of the inputs discussed herein and/or to the final output (e.g., lower the final score propionate to the department's remaining override budget). When a trip is completed, the actual spend can replace the estimate to ensure that collaboration management system 100 has the correct remaining spend available for each node in the organizational or project hierarchy.

Subsequent to seeing the system's recommendation as to whether or not physical travel is suggested (and/or to what extent), as shown in FIG. 10B, the begin travel search button 1018 may be selected if the client would like to proceed to schedule travel arrangements, with or without scheduling a telepresence event. In response, a shopping and fulfillment process can be activated utilizing distribution system 102, telepresence host system 104 and/or any other component(s) of collaboration management system 100 discussed herein.

As noted above, the shopping and fulfillment process shown at 908 of FIG. 9 can be implemented by processing circuitry 208 of distribution system 102 and/or processing circuitry 302 of telepresence host system 104. In some embodiments, the shopping and fulfillment process can comprise the utilization additional hardware (not shown) incorporated in one or more components of collaboration management system 100 and/or elsewhere.

FIG. 12 shows an exemplary process, namely process 1200, that may include the decision support tool in accordance with some embodiments discussed herein. Process 1200 starts at 1202.

At 1204, process 1200 can search for telepresence providers near or at the desired locations and then determine the availability of telepresence providers. For example, a plurality of criteria can be used by processing circuitry 302 of telepresence host system 104 to configure the search. The search criteria may be received from client input(s) and/or retrieved from database 312, among other things. For example, the search may be for telepresence providers 106 and 108, which may be located at hotels, large corporations, the requesting client's location, locations dedicated to facilitating virtual meetings, and/or any other location that may facilitate a virtual meeting. Availability processor 310 (discussed in reference to FIG. 3), for example, may be used to execute 1204.

The search conducted at 1204 may also be based on criteria associated with whether or not the client has already scheduled at least one physical travel component (e.g., air and hotel), as the location associated with the physical component may allow the system to automatically determine at least one of the locations to be used as a node of a telepresence bridge. As another example, the search may be configured to include criteria based on whether there is an enhanced travel component (e.g., such as the “meet-me-in-the-middle” approach), where multiple people may be traveling thereby providing an indication as to the size of the telepresence room that may be needed. As yet another example, the search can be configured to determine whether or not the video conferencing alternative is to even be considered. Whether a video conference alternative should be considered, like other search criteria (some of which are discussed herein), can be used as a precursor to determining the availability of telepresence providers in the proximity of the request. In some embodiments, the video conferencing option may only be included as part of the search solution if the user wants to consider video conferencing as an exclusive option or a partial “meet-me-in-the-middle” option.

In the case of a one-to-one meeting, the search configuration can be relatively straight forward. However, in the case of group travel, the search configuration criteria can be relatively more complex, with a solution that includes a combination of air, hotel and video conferencing. For example, when a client is trying to create travel and/or collaboration reservations, the client's computer can provide alternative options that can instead or additionally be shown to the client service representative and/or other type of user. The alternative options can include travel, other forms of meetings and/or collaboration alternatives as viable. The client and/or the client service representative will be able to reserve these collaboration options for the client.

At 1206, process 1200 can identify, for example, the type of one or more video conferencing centers and/or rooms equipped to facilitate a telepresence event, manufacturer and model types of the components at each center/room (for, e.g., compatibility determinations), the exact location and address of each center/room as well as any other information that may be used to determine possible telepresence locations. System compatibility processor 318 of telepresence host system 104, for example, may be configured to execute 1206.

At 1208, the rates associated with the available telepresence equipment may be determined. For example, rate processor 316 of telepresence host system 104 may be configured to determine the rate charged by a telepresence provider, which may be specific to particular clients based on, e.g., business rules stored in database 312 and managed by business rules processor 314.

At 1210, the client may be provided the available telepresence equipment, rates associated therewith (which may be specific to that client and/or other dynamic variables, such as the dates involved), the specific locations, and/or any other data that may assist the client in determining whether or not to book the services of the telepresence providers. For example, a display similar to display 600 of FIG. 6 may be presented at 1210.

At 1212, a decision may be made as to whether or not the decision support tool is to be utilized. For example, in response to the system determining the client's travel budget has been or is likely to be exceeded (e.g., is already operating in the override budget), the system may require that the client utilize the decision support tool before being authorized to schedule physical travel arrangements. In response to determining at 1212 that the decision support tool is to be utilized (e.g., either automatically, in response to receiving a client indication, or combination thereof), at 1214 the system may provide the client the return on investment calculator, such as that shown in FIG. 10B. At 1216, the system may receive the client's inputs from the return on investment calculator.

At 1218 the system may generate an output and present a recommendation as to whether or not physical travel should be scheduled. For example, a numeric value with an explanation, such as that shown in FIG. 10B, may be provided to the client.

At 1220, the client may schedule, for example, a telepresence event as discussed in connection with, e.g., FIG. 7. In response to determining at 1212 that the decision support tool is to be omitted from process 1200, process 1200 may advance from 1212 to 1220. Process 1200 may then end at 1222.

### Telepresence Centers

This scenario is based on embodiments where the room with the video conferencing, teleconferencing (telepresence providers 106 and 108 of FIG. 1), and/or any other type of remote collaboration equipment is available for hire (e.g., by the hour or other predetermined period of time) to a client from a third party. As mentioned above, some hotel chains and travel management companies may choose to invest in video conferencing and/or other types of facilities dedicated to facilitating remote collaboration. Collaboration management system 100 may allow these facilities to sell, among other things, their video conferencing service to clients. The telepresence providers may be independently owned and operated from the telepresence host system that schedules the usage and/or manages the availability of the telepresence and/or other equipment.

As noted above, collaboration management system 100 may provide clients options for conducting a telepresence event based on, for example, the client's proximity to the telepresence providers. Hence, a travel provider may be configured to access the corporate travel meeting planner (described above) and schedule a client's reservations to use the telepresence provider equipment.

From a distribution perspective, each telepresence provider facility (location could be a hotel or office building) that is rented through collaboration management system 100, can be associated with a unique identifier, such as a polygon identifier. The polygon identifiers can be different from or the same as what is used for hotels today by existing travel reservation systems.

The core capabilities that can be provided to the video conference provider include, for example, list pricing of time slots (day-parting) based on demand and available historical supply (this capability can be provided to hotel and/or travel management companies to benefit from time of day pricing to generate incremental revenues). As another example of a core capability, a competitive revenue management tool can be provided that may enable a video conference provider to adjust rates based on competitive availability. This may allow distribution system 102 to defer any challenge associated with determining rates and availability for the competitive set, which may reside in a polygon.

In some embodiments, while one or more components of collaboration management system 100 (e.g., distribution system 100 and/or telepresence host system 104) may charge a booking fee to the telepresence providers for bookings made through distribution system 102, distribution system 102 provides a number of additional, more advanced capabilities for a fee or for free (e.g., as an incentive to use distribution system 102 as a conduit for selling telepresence services and equipment use). For example, additional capabilities may include competitive rate shops for video conferencing centers within the polygon. Telepresence host system 104 should have access to competing video conferencing centers in a polygon that are distributed to distribution system 102 to provide numerous options (location, time slot availability and price) to the telepresence requestor. This feature also enables distribution system 102 to sell video conferencing time slots to the mid market, where a video conferencing facility is not available on site, where employees book through a specific travel provider. As another example of an additional capability provided by distribution system 102, network management capabilities for complex itineraries can be implemented. This can be used to provide a schedule from different individuals to meet at a specific video conferencing center. For example, employees from Sao Paolo and Rio de Janeiro may meet in Rio (Sao Paolo employees fly to Rio and this cost will be factored) to video conference with employees or clients in New York, thereby saving on several international long haul segments.

### Community and Social Networking

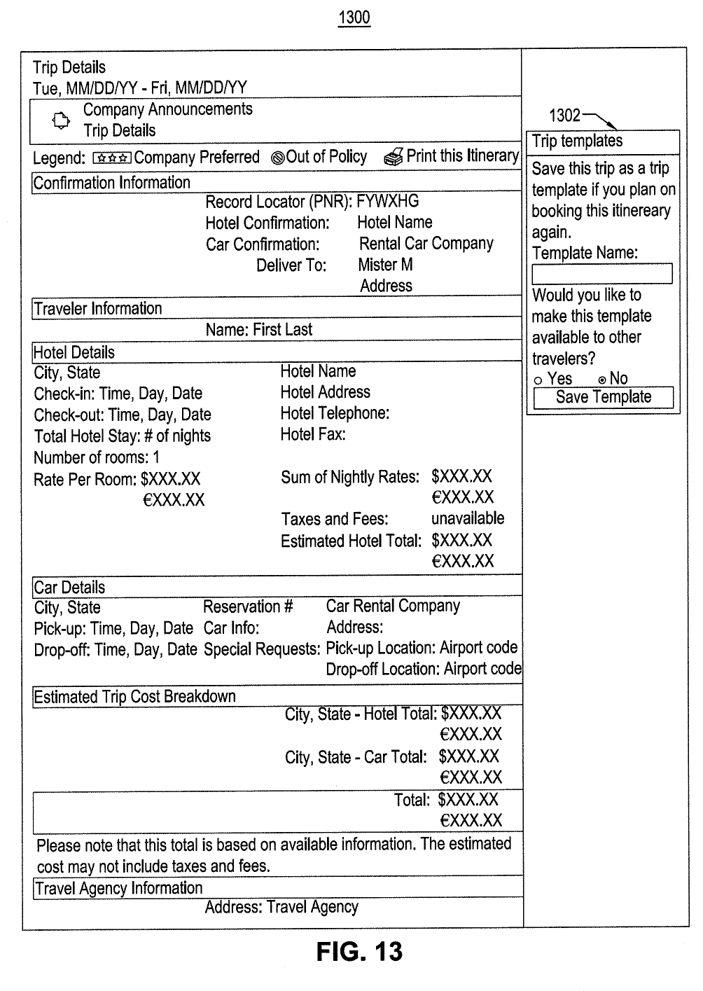

Some embodiments may also integrate corporate community and/or social networking with the booking engine, telepresence host system and/or other components collaboration management system 100. For example, display 1300 shown in FIG. 13 includes option 1302 to make a trip template based on the travel confirmation available to other travelers. If option 1302 is set to “yes,” the information of display 1300 may be used within a corporate and/or other type of social networking tool, and allow an end user or traveler to have the ability to publish and share trips/itinerary details via collaboration management system 100 to the community or a specific group. As another example, within an online travel workflow tool or an offline travel workflow tool, the integration and display to the user of content such as recommendations, comments, feedback and suggestions of community members could be made prior to, during and post booking.

### CONCLUSION

Many combinations and modifications to the embodiments discussed herein as well as other embodiments of the invention set forth herein will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system, comprising:
a processor configured to:
extract data from a request from a requestor to schedule a collaboration event, the data identifying a date and a location associated with the collaboration event; and
generate a telepresence option to schedule a telepresence meeting on the date and at the location using a first telepresence provider that is available to service the telepresence meeting; and
communications circuitry configured to:
transmit the telepresence option to the requestor, the telepresence option identifying the first telepresence provider that is available to service the telepresence meeting.

2. The system of claim 1, wherein the telepresence option includes a price to use the first telepresence provider's telepresence equipment.

3. The system of claim 2 further comprising:
a database configured to store one or more business rules associated with the request; and, wherein
the processor is further configured to:
retrieve the business rules; and
determine the price based on the business rules associated with the request.

4. The system of claim 1, wherein the telepresence option includes a second telepresence provider that is compatible with the first telepresence provider and is available to service the telepresence meeting.

5. The system of claim 1, wherein the processor is further configured to:
determine that physical travel is required to conduct the telepresence meeting at the location; and
provide a physical travel option to the requestor, the physical travel option including available travel arrangements to the location.

6. The system of claim 1, wherein the processor is further configured to:
determine a number of clients are to partake in the telepresence meeting;
determine a location associated with each of the clients;
determine a travel cost for all of the clients to travel to the location of each of the clients; and
determine a least expensive location for each of the clients to meet to conduct the telepresence meeting.

7. The system of claim 6 further comprising a second telepresence provider at the least expensive location, the second telepresence provider configured to service the telepresence meeting with the first telepresence provider at the location identified by the request.

8. The system of claim 1, wherein the processor is further configured to determine a return on investment for the collaboration event that includes physical travel arrangements.

9. The system of claim 8, wherein the return on investment is based at least partially on one or more qualitative measure inputs received from the requestor.

10. The system of claim 8, wherein the return on investment is based at least partially on the cost to use a corporate jet.

11. The system of claim 8, wherein the processor is configured to receive a payment confirmation of a fee before determining the return on investment.

12. A method, comprising:
receiving a request from a requestor to schedule a collaboration event, the request identifying a date and a location associated with the collaboration event;
generating, with circuitry, a telepresence option to schedule a telepresence meeting on the date and at the location using a first telepresence provider that is available to service the telepresence meeting; and
transmitting the telepresence option to the requestor, the telepresence option identifying a first telepresence provider that is available to service the telepresence meeting.

13. The method of claim 12, wherein generating the telepresence option includes determining a price to use the first telepresence provider's telepresence equipment.

14. The method of claim 13 further comprising:
storing one or more business rules associated with the request;
accessing the business rules; and
determining the price based on the business rules associated with the request.

15. The method of claim 12, wherein generating the telepresence option includes identifying a second telepresence provider that is compatible with the first telepresence provider, the second telepresence provider is available to service the telepresence meeting.

16. The method of claim 12, wherein generating the telepresence option includes:
determining that physical travel is required to conduct the telepresence meeting at the location; and
providing a physical travel option to the requestor, the physical travel option including available travel arrangements to the location.

17. The method of claim 12 further comprising:
determining a number of clients are to partake in the telepresence meeting;
determining a location associated with each of the clients;
determining a travel cost for all of the clients to travel to the location of each of the clients; and
determining a least expensive location for each of the clients to meet to conduct the telepresence meeting.

18. The method of claim 17 further comprising conducting the telepresence meeting between the least expensive location and the location identified by the request.

19. The method of claim 12 further comprising determining a return on investment for the collaboration event that includes physical travel arrangements.

20. The method of claim 19, wherein determining the return on investment includes receiving one or more qualitative measure inputs from the machine.

21. The method of claim 19, wherein determining the return on investment includes receiving information regarding costs to use a corporate jet.

22. The method of claim 19 further comprising charging a fee to determine the return on investment.

23. A method comprising:
presenting, with circuitry, a display that includes an option to schedule a telepresence event, wherein presenting the display includes presenting telepresence provider information identifying:
telepresence equipment;
at least one date the telepresence equipment is available;
at least one time the telepresence equipment is available; and
a fee associated with using the telepresence equipment at the time and date.

24. A system comprising:
at least two telepresence providers;
a telepresence host system that is configured to determine the availability of the at least two telepresence providers and book the use of the at least two telepresence providers;
a global distribution system that is configured to:
book first travel arrangements for a first client to travel to a first of the at least two telepresence providers; and
book second travel arrangements for a second client to travel to a second of the at least two telepresence providers.
